(19) United States
(12) Patent Application Publication
(10) Pub. No.: US 2026/0190063 A1
(43) Pub. Date: Jul. 2, 2026

(54) KEY AGREEMENT AFTER LOCAL RELEASE BY A USER EQUIPMENT (UE) IN A WIRELESS COMMUNICATION SYSTEM

(71) Applicant: Google LLC, Mountain View, CA (US)

(72) Inventors: Shih-Che Chou, Taipei (TW); Chien-Chun Huang Fu, Taipei (TW); Edison Chen, Taipei (TW); Stan Lin, Taipei (TW)

(21) Appl. No.: 19/413,257

(22) Filed: Dec. 9, 2025

Related U.S. Application Data
(60) Provisional application No. 63/739,562, filed on Dec. 28, 2024.

(51) Int. Cl. H04W 60/04; H04W 12/043; H04W 12/06; H04W 60/06; H04W 76/30

(52) U.S. Cl. CPC H04W 60/04; H04W 12/043; H04W 12/06; H04W 60/06; H04W 76/30

(57) ABSTRACT

This disclosure provides systems, methods and apparatuses in which a user equipment (UE) (102) maintains synchronization of a security context with a core network (CN) (110) during UE-initiated maintenance operations. In some aspects, the UE performs a temporary local release (130B) and starts a timer. The UE performs the maintenance operations for example, software updates, frequency shifting, radio link failure recovery, and the like. If the maintenance operations complete before expiration of the timer, the UE resumes a registered state. If the timer expires before the maintenance operations complete, the UE performs security context synchronization operations (150). In some aspects, the UE performs operations that can trigger the CN to perform authentication and key agreement procedures, thereby synchronizing security context between the UE and the CN.

### RELATED APPLICATION

This application claims the priority benefit of U.S. Provisional Patent Application Ser. No. 63/739,562 entitled “KEY AGREEMENT AFTER LOCAL RELEASE BY A USER EQUIPMENT (UE) IN A WIRELESS COMMUNICATION SYSTEM” and filed Dec. 28, 2024, the entire contents of which is incorporated herein by reference.

### TECHNICAL FIELD

This disclosure relates generally to wireless communication and some aspects relate to techniques for maintaining key agreement between a user equipment (UE) and a core network.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A wireless communication system provides resources for a user equipment (UE) to access one or more services. The wireless communication system typically includes one or more radio access networks (RANs) communicatively coupled to a core network (CN). The UE communicates via a radio connection between the UE and a RAN using access stratum (AS) protocol layers that are based on the radio access technology (RAT) of the RAN. After establishing a radio connection to the RAN, the UE can register with the core network and request services using a non-access stratum (NAS) protocol layer. The core network manages UE access to the services, network slices, and packet data networks using NAS protocols. The 3rd Generation Partnership Project (3GPP) technical specifications (TSs) standardize the AS and NAS protocols.

### BRIEF SUMMARY

The systems, methods, and apparatuses of this disclosure each have several innovative aspects, no single one of which is solely responsible for the desirable attributes disclosed herein.

One innovative aspect of the subject matter described in this disclosure can be implemented as a method for wireless communication by a user equipment (UE). The method includes the UE transmitting, to a core network (CN), a first registration request message indicating a first security context. The UE receives, from the CN, an authentication request message indicating a second security context. The UE starts a maintenance operations timer indicating an allowable time for maintenance operations. The UE performs a temporary local release for a communication session. The UE initiates one or more of the maintenance operations. The UE resumes at least one of a registered state or one or more registration operations when the one or more maintenance operations complete before the maintenance operations timer expires.

Another innovative aspect of the subject matter described in this disclosure can be implemented as an apparatus that includes a communication unit and a processing system configured to control the communication unit to: transmit, to a core network (CN), a first registration request message indicating a first security context; receive, from the CN, an authentication request message indicating a second security context; start a maintenance operations timer indicating an allowable time for maintenance operations; perform a temporary local release for a communication session; initiate one or more of the maintenance operations; and resume at least one of a registered state or one or more registration operations when the one or more maintenance operations complete before the maintenance operations timer expires.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE DRAWINGS

Like reference numbers and designations in the various drawings indicate like elements. Note that the relative dimensions of the figures may not be drawn to scale. To easily identify the discussion of any particular element or act, the most significant digit or digits in a reference number refer to the figure number in which that element is first introduced.

FIG. 1A is a block diagram illustrating an example wireless communication system in which a user equipment (UE) maintains synchronization of a security context with a core network (CN) following a temporary local release or local deregistration.

FIG. 1B is a block diagram illustrating example security contexts before and after a local deregistration.

FIG. 2A is a block diagram illustrating an example control plane protocol stack in which the example wireless communication system of FIG. 1A is a 5th generation system (5GS).

FIG. 2B is a block diagram illustrating an example control plane protocol stack in which the example wireless communication system of FIG. 1A is a 4th generation system evolved packet system (EPS).

FIG. 3A is a state diagram illustrating various UE registration states and a temporary local release during a registered state.

FIG. 3B is a state diagram illustrating various UE registration states and a temporary local release prior to a registration initiated state.

FIG. 3C is a state diagram illustrating various UE registration states and a temporary local release prior to a registered state.

FIG. 4 is a communication signaling diagram illustrating example operations in which a UE attempts to reregister with a CN following a local deregistration.

FIG. 5A is a communication signaling diagram illustrating example operations in which a UE synchronizes a security context with a CN based on a partial native security context key that was stored by the UE.

FIG. 5B is a communication signaling diagram illustrating example operations in which a UE maintains security context synchronization with a CN when performing maintenance operations.

FIG. 6 is a communication signaling diagram illustrating example operations in which a UE synchronizes a security context with a CN using a subscription concealed identifier (SUCI) and indicating that no key is available.

FIG. 7 is a communication signaling diagram illustrating example operations in which a UE synchronizes a security context with a CN using an international mobile subscriber identity (IMSI) and indicating that no key is available.

FIG. 8 is a communication signaling diagram illustrating example operations in which a UE synchronizes a security context with a CN via a deregistration request.

FIG. 9 is a communication signaling diagram illustrating example operations in which a UE falls back to long term evolution (LTE) operation to synchronize a security context with a CN.

FIG. 10A is a flowchart diagram illustrating example operations in which a UE synchronizes a security context with a CN based on a partial native security context key that was stored by the UE.

FIG. 10B is a flowchart diagram illustrating example operations in which a UE maintains security context synchronization with a CN when performing maintenance operations.

FIG. 11 is a flowchart diagram illustrating example operations in which a UE synchronizes a security context with a CN by indicating that no key is available after a local deregistration.

FIG. 12 is a flowchart diagram illustrating example operations in which a UE synchronizes a security context with a CN via a deregistration request.

FIG. 13 is a flowchart diagram illustrating example operations in which a UE falls back to LTE operation to synchronize a security context with a CN.

FIG. 14 is a flowchart diagram illustrating example operations in which a UE maintains security context synchronization with a CN when performing maintenance operations.

FIG. 15 is a block diagram of an example wireless communication system showing hardware features and communication interfaces.

### DETAILED DESCRIPTION

The following description is directed to certain implementations for the purpose of describing innovative aspects of this disclosure. However, a person having ordinary skill in the art will readily recognize that the teachings herein can be applied in a multitude of different ways. Some of the examples in this disclosure are based on wireless communication according to the 3rd Generation Partnership Project (3GPP) wireless standards, such as the 4th generation (4G) Long Term Evolution (LTE) and 5th generation (5G) New Radio (NR) standards. However, the described implementations can be implemented in any device, system, or network that is capable of transmitting and receiving radio frequency signals according to any of the wireless communication standards, including any of the Institute of Electrical and Electronics Engineers (IEEE) 802.11 or 802.16 wireless standards, or other known signals that are used to communicate within a wireless, cellular, or internet of things (IoT) network, such as a system utilizing 4G, 5G, sixth generation (6G), WiFi, or future radio technology.

Various techniques of the disclosure relate to maintaining security context synchronization between a user equipment (UE) and a core network (CN). The techniques can reduce delays related to a UE establishing and maintaining communications in a wireless network when the security context of the UE is out of synchronization with the CN, for example, in cases where maintenance operations (or other UE operations) take too long or when the UE locally deregisters from the CN prior to establishing a full security context with the CN. In some aspects, the UE starts a timer for maintenance operations. Even though the maintenance operations might prevent the UE from communicating with the CN, the UE remains in a registered state and maintains the security context as long as the UE completes the maintenance operations before expiration of the timer. If the timer expires before the UE completes the maintenance operations, the UE enters a deregistered state and might become out of synchronization with the security context of CN. In some aspects, the UE uses one or more of the techniques (singly or in combination) of this disclosure to resynchronize security contexts on the UE and the CN. Resynchronization can also be referred to as restoring security context, key synchronization, key matching, key alignment, or other similar terms or phrases.

As stated above, a wireless communication system provides resources for a UE to access one or more services provided by a CN via a radio access network (RAN). After establishing a radio connection to the RAN, the UE can register with the core network and request services using a non-access stratum (NAS) protocol layer. The core network manages UE access to the services, network slices, and packet data networks using NAS protocols.

When the UE registers with the CN, the UE and the CN establish a security context. In a 5G wireless communication system, the security context can be referred to as a 5G NAS security context. The security context includes a key set identifier that indicates one or more keys used to ensure privacy, authenticity, and integrity of communications between the UE and the CN. For example, authentication and key agreement (AKA) is a combination of an authentication process to verify that the UE and the CN are genuine and a key agreement process to establish one or more shared keys for encryption. An AKA is followed by a NAS security mode command and access stratum (AS) security mode control (SMC) procedures to establish a security context.

A security context refers to an agreement of the security settings (including key(s), state, encryption algorithm, integrity protection algorithm, and security mode) between the UE and the CN. For example, a 5G NAS security context includes a 5G key set identifier (KSI, also referred to as a next generation key set identifier (ngKSI)) stored in the UE and an access and mobility management function (AMF) of the 5G CN (also referred to as a 5GC). The AMF also stores a key (referred to as KAMF) for the 5G NAS security context.

A security context can be mapped, full native, or partial native. A full native security context is one which includes encryption keys and enabled security mode. A security context is referred to as a partial native security context when encryption keys are established but the security mode is not yet enabled. A mapped security context occurs when security keys are derived from an LTE CN (also referred to as an EPC) using 5GC-EPS interworking. A “current” security context refers to the most recently activated security context, which may be a mapped or full native security context. A “non-current” security context can be a full or partial native security context that is not currently used. A partial native security context is always considered non-current until it is promoted to a current full native security context using a security mode command (SMC).

To establish authentication and encryption, a key on the UE is synchronized with the key on the AMF. Typically, the UE and the CN perform authentication to establish a common key set identified by a 5G key set identifier (i.e., ngKSI). As part of authentication, the UE transmits a NAS registration request to the CN entity via the RAN. After a successful authentication, the CN and the UE create keys (KAMF and ngKSI 0) for a partial-native security context. The UE and the CN entity then set a security mode using a security mode command. The security mode indicates encryption algorithms and integrity protection algorithms used for exchanging data between the UE and the CN. After the security mode is set, the partial-native security context becomes a full-native security context. The UE and the CN entity use the ngKSI 0 and KAMF associated with the full-native security context for authentication, encryption, and integrity checking for data exchanged between the UE and the CN.

In some examples, the UE may register with a 5GC and establish a 5G security context with a first key set identifier (e.g., “ngKSI 0”). In some examples, the UE may register with an EPC, thereby creating an LTE security context associated with the EPC. In some examples, the UE previously registered with a 5GC and the UE has a non-current full-native or partial security context. If the UE was previously registered to an EPS, the UE can map the LTE security context to a 5G security context to establish a mapped security context in the 5GC. The UE uses the non-current full-native or partial security context (or the mapped security context) for the registration request to the CN (e.g., the 5GC). In response to the registration request, the CN establishes a partial-native security context with a second key set identifier (e.g., “ngKSI 1”). Following a successful registration, the UE and the CN can set the security mode (e.g., using a security mode command) to add security information, thereby changing the partial-native security context to a full-native security context.

In some situations, the UE may perform operations during a communications session with the CN. For consistency, this disclosure refers to all such operations as maintenance operations. The term “maintenance operations” can be replaced with UE operations, “operations” (for brevity), or any other term that refers to operations or procedures at the UE that do not traditionally involve NAS communication with the CN. As examples, the UE may update software, switch to a different subscriber identity module (SIM) card (virtual or physical), or attempt to recover from a radio link failure, among others. If the UE can perform the maintenance operations before the CN determines that the UE has dropped the communications session, the UE can maintain security context synchronization with the CN. In some aspects, a UE starts a timer to maintain the security context during maintenance operations. In some implementations, the timer is a countdown timer initialized with a starting value. The starting value of the timer controls the duration of the timer. The starting value can be a network-configurable, user-configurable, a predefined/specified value (e.g., in a 3GPP technical specification), or dynamic value based on a pattern or history of previous maintenance operations. As examples, the duration of the timer might be 5 seconds(s), 10 s, 15 s, 30 s, or any other value. As long as the UE completes the maintenance operations before the timer expires, the UE can remain in the registered state and avoid deleting an existing security context.

In some cases, the maintenance operations may take up too much time and the CN determines that the UE has dropped the communications session. For example, the UE may not complete the maintenance operations before expiration of the timer. As a result, the UE may perform a local detach, deregister with the network, and/or delete a security context. In such cases, the security context of the UE may no longer be the same as the security context of the CN. For example, the key set identifiers on one or both the UE and the CN may become deleted or mismatched.

In some situations, the first key set identifier (ngKSI 0) at the UE can become unsynchronized with the key set identifier (ngKSI 1) at the CN. For example, the UE might deregister from the CN without the CN's knowledge. As one example, the UE may perform a local deregistration (also referred to as a “UE-initiated deregistration”). As another example, the UE may transmit a deregistration request to the CN that is not received by the CN (perhaps due to a poor wireless communication connection). Typically, as part of a deregistration, the UE deletes the mapped security context and the partial-native security context, and the UE maintains the full-native security context (with ngKSI 0) that was previously used for the 5G registration request as a non-current full-native security context. The CN, not knowing that the UE has deregistered locally, may attempt to set the security mode by transmitting a security mode command to the UE using a key set identifier (ngKSI 1) of the partial-native security context. Because the UE does not recognize the partial-native security context, the UE responds to the security mode command with a security mode reject message (referred to as “security mode reject” for brevity). The mismatch of security context can be referred to as an unsynchronized security context or similar terms (such as out of synchronization, not aligned, unaligned, not harmonized, not matched, mismatched, and the like) in which the UE's stored security context and associated key set identifier (e.g., the first key set identifier, ngKSI 0) is not synchronized with the CN's stored security context (e.g., the partial-native security context associated with the second key set identifier, ngKSI 1).

In some scenarios, when the UE detects a security context failure (e.g., a failure due to maintenance operations taking too long or a local deregistration), the UE retries to register with the network entity by transmitting registration requests to the CN using the first key set identifier (ngKSI: 0). The retries can result in significant delays in establishing a valid security context between the UE and the network entity. As an example, the UE may be restricted to limited service for up to two minutes and may be unable to request 5G services for up to 12 minutes. During such limited service periods, the UE may be unable to access services. For example, the UE may be limited to making emergency calls, attempting to connect to other networks (e.g., LTE or 3G networks), monitoring for paging information from the network, or performing location updates, among other limited services. The UE may be unable to send or receive voice data (outside of emergency calls) during periods of limited service. The delays in establishing a valid 5G security context and the resulting limitations to services that the network can provide to the UE can lead to user frustration and dissatisfaction.

Particular implementations of the subject matter described in this disclosure can be implemented to realize one or more of the following potential advantages. In some aspects, a UE can maintain security context while performing maintenance operations (i.e., during a temporary local release) without deregistering from the CN. Doing so enables the UE to resume the registered state more quickly and avoid communication overhead/delay associated with registration. In some aspects, techniques of this disclosure enable a UE to restore a security context quickly using a stored key or other identifier to authenticate a registration with the core network if the security context becomes unsynchronized.

In this disclosure, several example scenarios are discussed with reference to various figures. Generally speaking, similar events in the figures are labeled with the same or similar reference numbers, with differences discussed where appropriate. With the exception of the differences shown in the figures and discussed below, any of the alternative implementations discussed with respect to a particular event (e.g., for messaging and processing) may apply to events labeled with similar reference numbers in other figures.

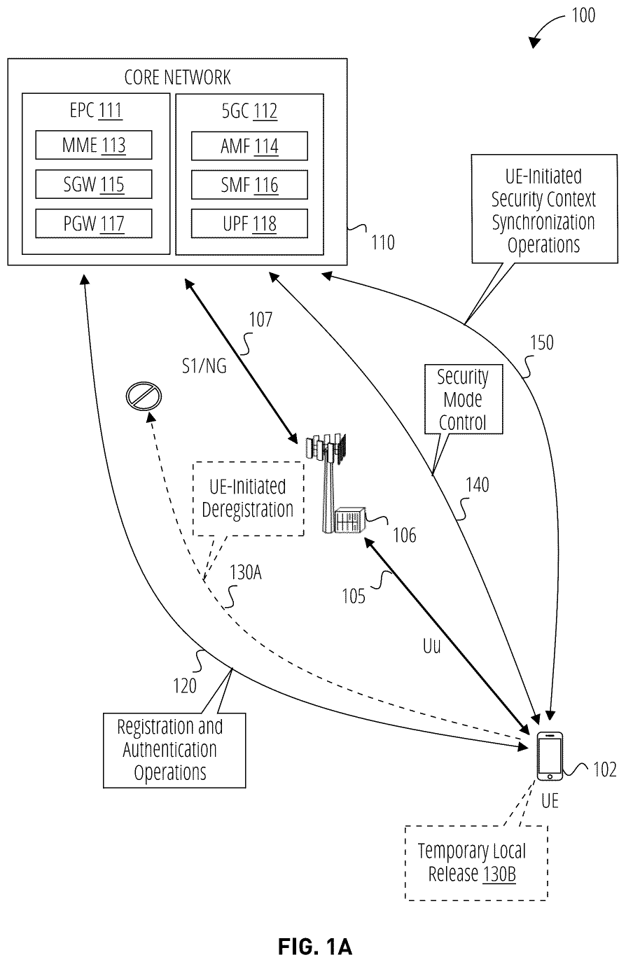

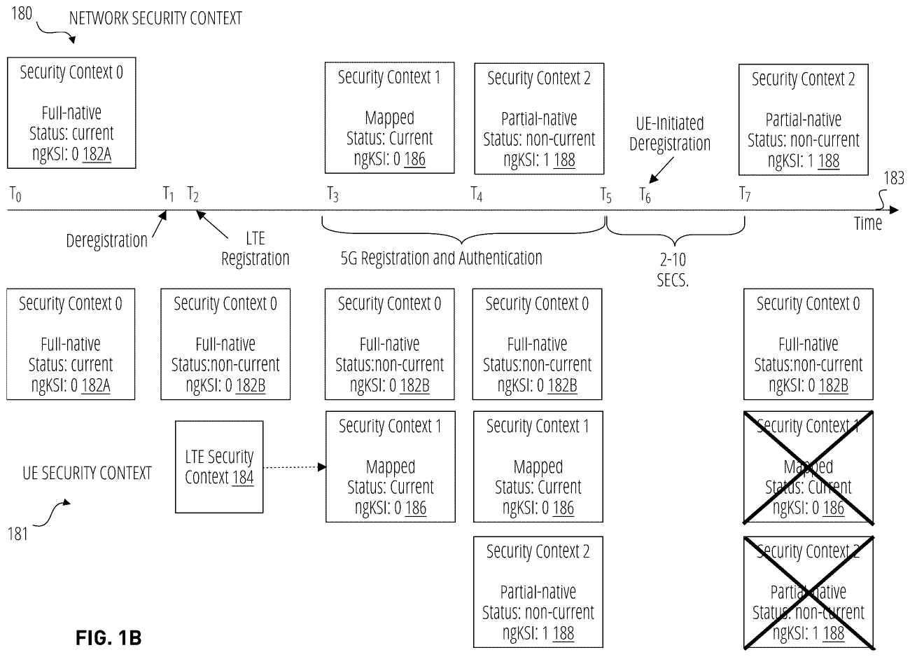

FIG. 1A is a block diagram illustrating an example wireless communication system in which a UE synchronizes a security context with a CN following a local deregistration. While FIG. 1A describes an example architecture of a wireless communication system, other architectures are possible. The example wireless communication system 100 includes a UE 102, a base station (BS 106), and a core network (CN 110). Although illustrated as a smartphone in FIG. 1A, the UE 102 can be implemented as any suitable computing or electronic device, such as a mobile communication device, a modem, cellular phone, gaming device, navigation device, media device, laptop computer, desktop computer, tablet computer, smart appliance, vehicle-based communication system, an Internet-of-things (IoT) device (e.g., sensor node, controller/actuator node, combination thereof), and the like.

The BS 106 supports wireless communication with one or more UEs via radio frequency (RF) signaling using one or more applicable radio access technologies (RATs) as specified by one or more communications protocols or standards. The BS 106 may employ any of a variety of RATs, such as operating as a NodeB (or base transceiver station (BTS)) for a Universal Mobile Telecommunications System (UMTS) RAT (also known as “3G”), operating as an enhanced NodeB (“eNB”) for a Third Generation Partnership Project (3GPP) Long Term Evolution (LTE) RAT, operating as a 5G node B (“gNB”) for a 3GPP Fifth Generation New Radio (5G NR) RAT, and the like. The BS 106 (e.g., Evolved Universal Terrestrial Radio Access Network Node B (E-UTRAN Node B), evolved Node B, eNodeB, eNB, Next Generation Node B, gNodeB, gNB, ng-eNB, access point, radio head or the like), may be implemented in a macrocell, microcell, small cell, picocell, or the like, or any combination thereof. In some aspects, the functionality, and thus the hardware components, of the BS 106 are distributed across multiple network nodes or devices and are distributed in a manner to perform the functions described herein. As one example, the functionality of the BS 106 is distributed across a radio unit (RU), distributed unit (DU), or central unit (CU).

The CN 110 can be an evolved packet core (EPC 111) or a fifth generation (5G) core (5GC 112), for example. Alternatively, the CN 110 might be a sixth generation (6G) core. The BS 106 operates a RAN and is connected to the CN 110. The BS 106 and the CN 110 belong to a Public Land Mobile Network (PLMN). The BS 106 can be a terrestrial base station, and the PLMN may be referred to as a terrestrial network (TN). Alternatively, the PLMN can be a non-terrestrial network (NTN) and the BS 106 might employ NTN technology. For example, the BS 106 can be communicatively coupled, or integrated, with an airborne or spaceborne vehicle.

In general, a RAN can include any number of base stations, and each of the base stations can cover one, two, three, or any other suitable number of cells. The BS 106 operates a cell (not shown) providing coverage for the UE 102. If the BS 106 is a gNB, the cell is an NR cell. If the BS 106 is an ng-eNB or eNB, the cell is an evolved universal terrestrial radio access (E-UTRA) cell. The UE 102 can support at least a 5G NR (or simply, “NR”) or E-UTRA air interface to communicate with the BS 106. The BS 106 can connect to the CN 110 via an interface (e.g., S1 or NG interface 107). The BS 106 and other base stations (not shown) in a RAN also can be interconnected via an interface (e.g., X2 or Xn interface) for interconnecting RAN nodes. The UE 102 can have a radio connection to the BS 106 via a user interface (e.g., Uu interface 105). The Uu interface 105 also can be referred to as an access stratum (AS). The non-access stratum (NAS) includes communications between the UE 102 and the CN 110, where the communications traverse both the Uu interface 105 and the S1/NG interface 107.

Among other components, the EPC 111 may include a Serving Gateway (SGW) 115, a Mobility Management Entity (MME) 113, and a Packet Data Network Gateway (PGW) 117. The SGW 115 in general is configured to transfer user-plane packets related to audio calls, video calls, Internet traffic, etc. The MME 113 is configured to manage authentication, registration, paging, and other related functions. The PGW 117 provides connectivity from the UE to one or more external packet data networks, e.g., an Internet network and/or an Internet Protocol (IP) Multimedia Subsystem (IMS) network. The EPC 111 may include other MMEs, SGWs and/or PGWs not shown in FIG. 1A.

The 5GC 112 includes a User Plane Function (UPF) 118, an Access and Mobility Management Function (AMF) 114, and/or Session Management Function (SMF) 116. The UPF 118 is configured to transfer user-plane packets related to audio calls, video calls, Internet traffic, etc. The AMF 114 is configured to manage authentication, registration, paging, and other related functions. The SMF 116 is configured to manage protocol data unit (PDU) sessions. The 5GC 112 may include other AMFs, SMFs and/or UPFs not shown in FIG. 1A.

Generally speaking, a base station operating a RAN communicates with a UE using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

After the UE 102 registers with the CN 110, a CN node of the CN 110 manages UE parameters while the UE 102 is registered to the CN 110. In the case of the EPS, the CN node is MME 113; and in case of the 5GS, the CN node is the AMF 114. In addition to the AMF 114, the SMF 116 can serve as a CN node to implement part of a NAS layer. For brevity, this disclosure refers to operations of the CN node (or just core network) to represent operations that might be performed by the MME 113, the AMF 114, or the SMF 116.

As part of the registration process, the UE 102 and the CN 110 establish a security context for use in authentication, encryption, and integrity checking messages exchanged between the UE 102 and the CN 110. There are several types of security contexts depending on the stage of registration and previous connections between the UE 102 and CNs (which may or may not include CN 110). A native security context is a security context that is associated with the current RAT being used for communication between the UE 102 and a CN. For example, a security context designed for 5G communications is a native security context when the UE 102 and the CN are using a 5G RAT. Similarly, a security context designed for 4G communications is a native security context when the UE 102 and the CN are using a 4G RAT.

A mapped security context is a 5G security context that has been derived from a 4G security context. For example, a UE may operate in a 4G mode and may transition to a 5G mode (perhaps in response to an improved communications environment). As part of the transition, the UE and CN may derive 5G security context parameters from the 4G security context, thereby saving time by avoiding some of the registration processes necessary to establish a 5G security context.

A native security context may be a full-native security context or a partial-native security context. As part of registration and authentication operations 120, the UE 102 sends a registration request message to the CN 110. The CN 110 authenticates the UE 102 in response to the registration request. Upon successful authentication, a partial-native security context exists on the UE 102 and CN 110. The security context may be considered partial because not all of the security parameters are established. For example, the encryption algorithms to be used for data exchange between the UE 102 and CN 110 are not yet established. The UE 102 and CN 110 perform a security mode control 140 to establish these additional security context parameters. Upon successful completion of the security mode control 140, a full-native security context exists and the UE 102 and the CN 110 can securely exchange data with one another using the encryption and integrity checking algorithms indicated in the security context.

In addition to the type, a security context may have a status of “current” or “non-current.” A current security context is the security context that is currently in use by the UE 102 and CN 110. A non-current security context is a security context that is not currently in use by the UE 102 or CN 110. For example, the UE 102 may deregister from the CN 110. After deregistration, the current security context becomes a non-current security context. The UE 102 may save the non-current security context, which the UE 102 can use to save time and resources when reestablishing a communications session with the CN 110. For example, the UE 102 and the CN 110 can promote the non-current security context to a current security context. Alternatively or additionally, the non-current security context can provide some of the security parameters for a new current security context.

Table 1 below shows valid type and status combinations for a full-native, partial-native, and mapped security context. As shown in Table 1, a full-native security context may have a current or non-current status. A partial-native security context may not be a current security context, but can be valid as a non-current security context. A mapped security context may be a current security context, but cannot be a valid non-current security context. This is because a mapped security context is deleted if a native security context is established.

TABLE 1

| Type | Current | Non-Current |
|---|---|---|
| Full-Native | OK | OK |
| Partial-Native | NO | OK (Always) |
| Mapped | OK | NO |

In the example shown in FIG. 1A, during a normal (e.g., successful) registration with a network, the UE 102 initiates registration and authentication operations 120 by communicating a registration request via the BS 106 to the CN 110. The CN 110 then authenticates the UE 102. The UE 102 and the CN 110 then perform security mode control 140 to establish a full-native security context. After successful security mode control 140, the UE 102 and CN 110 can securely communicate using the encryption, authentication, and integrity checking algorithms indicated in the full-native security context established after the successful security mode control 140.

In some situations, the UE 102 and the CN 110 may not successfully complete the security mode control 140 after the registration and authentication operations 120 are completed. For example, between registration and authentication operations 120 and security mode control 140, the UE 102 may perform a temporary local release 130B or a UE-initiated deregistration 130A (e.g., a local deregistration). In the case of a UE-initiated deregistration 130A, the CN 110 may be unaware that the UE 102 has locally deregistered. As one example, the UE 102 may transmit a deregistration request to the CN 110 that is not received by the CN 110 (perhaps due to a poor communications environment). As another example, the UE 102 may perform a UE-initiated deregistration 130A without informing the CN 110 of the deregistration. As a result of the UE-initiated deregistration 130A, the security context of the UE 102 does not match the security context of the CN 110 (e.g., the security context is not synchronized between the UE 102 and the CN 110). In the case of a temporary local release 130B, the UE may perform maintenance operations between registration and authentication operations 120 and security mode control 140. If such maintenance operations consume too much time, the UE may not be able to synchronize security context with the CN 110.

FIG. 1B is a block diagram illustrating example security contexts before and after a local deregistration. The example shown in FIG. 1B illustrates an example scenario in which the security context of the UE 102 and the security context of the CN 110 eventually do not match because of a local deregistration of the UE 102. In the example scenario shown in FIG. 1B, the security contexts 180 appearing above time line 183 represents one or more security contexts maintained by the CN 110. The security contexts 181 appearing below the time line 183 represent the security contexts maintained by the UE 102. The time line 183 shown in FIG. 1B is not to scale, and the periods between the identified points t₀-t₇ may be different than that shown in the time line 183. FIG. 1B will be discussed in conjunction with FIG. 1A.

In the example scenario presented in FIG. 1B, at time to, the UE 102 successfully completes 5G registration and authentication operations 120 with the CN 110 and successfully completes security mode control 140 procedures. For the purposes of this example, the UE 102 may register with a 5G network while the user is at the user's office. Both the UE 102 and the CN 110 maintain a matching security context 182A. The security context 182A includes a ngKSI which will be referred to as ngKSI 0. The ngKSI identifies a set of one or more security keys used for encryption, authentication, and integrity checking for a communication session associated with the security context 182A. Security context 182A is a current full-native security context.

At time t₁, the UE 102 deregisters from the CN 110. For example, the user may leave the office and may no longer be in proximity to the 5G network. The formerly current security context 182A becomes non-current security context 182B.

At time t₂, the UE 102 registers with an LTE network. The CN (e.g., EPC 111) associated with the LTE network and the UE 102 establish an LTE security context 184 for secure communications over the LTE network. After time t₂, the UE 102 maintains two security contexts, non-current full-native security context 182B, and current LTE security context 184.

At time t₃, the user returns to the office and the UE 102 initiates registration and authentication operations 120 with CN 110. The UE 102 and the CN 110 promote the LTE security context 184 to a mapped security context 186 that includes ngKSI 0. Additionally, the UE 102 has maintained the non-current full-native security context 182B. At time t₄, in response to the registration request, the CN 110 attempts to authenticate the UE 102 and generates a new partial-native security context 188 with a new key indicator, ngKSI 1. The new security context is a partial-native security context because it is missing security parameters that are established by security control mode procedures, which have not yet been executed by the UE 102 and the CN 110. The partial-native security context 188 is non-current because it is not in use by the UE 102 or the CN 110. At time t₄, the CN 110 has the partial-native security context 188. The UE 102 has the partial-native security context 188, the mapped security context 186, and the non-current full-native security context 182B.

The time between completion of registration and authentication operations 120 (e.g., time t₅) and the initiation of security mode control 140 (e.g., time t₇) can be between two and ten seconds. In the example shown in FIG. 1B, at time to and prior to completing security mode control 140, the UE 102 performs a UE-initiated deregistration 130A, where the deregistration is not known to the CN 110. For example, in some aspects the UE 102 performs a local deregistration without informing the CN 110 of the deregistration. In some other aspects, the UE 102 transmits a deregistration request that is not received by the CN 110. In accordance with existing specifications for 5G deregistration, the UE 102 deletes the partial-native security context 188 and the mapped security context 186, leaving the non-current full-native security context 182B.

At time to, the CN 110, unaware that the UE 102 has performed a UE-initiated deregistration, initiates security mode control 140 procedures using its newly created partial-native security context 188 and the key ngKSI 1. The UE 102 receives a security mode command from the CN 110 indicating the non-current partial-native security context 188 and ngKSI 1. The UE 102 rejects the security mode command because the UE 102 no longer has a security context matching ngKSI 1, having deleted its copy of security context 188 when the UE 102 deregistered. The remaining security context maintained by the UE 102 is non-current full-native security context 182B. The key associated with this security context is ngKSI 0. Because the key used by the CN 110 (e.g., ngKSI 1) is not in synchronization with the key used by the UE 102 (ngKSI 0), the UE 102 rejects the security mode command.

After rejecting the security mode command, the UE 102 may retry registration with the CN 110 using the non-current full-native security context 182B and key indicator ngKSI 0. In some aspects, the UE 102 retries registration for up to five times. These retries by the UE to register with the CN 110 are likely to fail because of the mismatch in security contexts and security key indicators between the UE 102 and the CN 110. The UE's repeated attempts to register might take as long as two minutes, during which time the UE 102 might provide limited or no service. Further, if the UE 102 transmits multiple unsuccessful registration requests, the CN 110 might instruct the UE 102 to defer further attempts at registration for a period of twelve minutes. During this time, the UE cannot access 5G services provided by CN 110. As noted above, the user of UE 102 might become frustrated and dissatisfied due to the restriction to limited service (or no service) and delays in the ability to access 5G services.

The techniques of this disclosure can enable the UE 102 to synchronize (or resynchronize) a security context with the CN 110 in the event that security contexts and key indicators become unsynchronized between the UE 102 and the CN 110. This disclosure describes various implementations, which may be referred to as UE-initiated security context synchronization operation(s) 150, synchronization operations, or synchronization, resynchronization, or any other terms for reestablishing an unsynchronized security context. In some aspects, the UE 102 maintains a partial-native security context or a mapped security context following a UE-initiated deregistration 130A from the network. The UE 102 may complete a security mode control 140 procedure with the CN 110 using the partial-native security context or the mapped security context. By maintaining the partial-native security context or the mapped security context, the UE 102 can more easily restore a security context and synchronize keys using the previous partial-native security context or mapped security context.

In some aspects, the UE 102 transitions from operating using a first radio access technology (RAT) to operating using a second RAT. As examples, the UE 102 transitions from a 5G RAT to an LTE RAT or from a 6G RAT to a 5G RAT. The UE 102 can use security information in the mapped security context to complete the key synchronization. For example, the UE 102 transmits one or more attach requests to the CN 110. In some aspects, the attach requests include a globally unique temporary identifier (GUTI). An attach request may include an international mobile subscriber identity (IMSI).

In some aspects, the UE 102 transmits a deregistration request to the CN 110. For example, the UE 102 transmits the deregistration request following a deregistration that is otherwise not known to the CN 110. For example, following a local deregistration or a previous deregistration request not received by the CN 110, the UE 102 transmits a deregistration request. After the deregistration request, the UE 102 transitions from 5G to LTE operation and transmits one or more attach requests including a GUTI or IMSI.

In some aspects, the UE 102 transmits one or more registration requests following the deregistration where the registration requests include an indication that no key is available on the UE. In some aspects, the registration requests also include other authentication material (such as subscription concealed identifier (SUCI) that is used to encrypt a subscription permanent identifier (SUPI), or an IMSI to shorten the AKA process for establishing a new security key. Potential technical advantages of this approach are that an AKA process can be triggered sooner, some AKA-related messaging can be avoided, and the UE can restore a security context faster than is the case in current systems.

One potential technical advantage associated with the techniques of the disclosure is that the UE 102 may reestablish secure wireless communications with a network in less time than in existing systems in cases where a deregistration by the UE 102 is not known to the CN 110. Further, the UE 102 may be able to request network services in less time than in existing systems following such a deregistration.

It should be noted that the example scenario of FIG. 1A and FIG. 1B are just one example of how the security context of the UE 102 and the CN 110 can become mismatched or out of synchronization. Other scenarios may exist and the techniques discussed herein for bringing the security context and key set identifiers of the UE 102 and the CN 110 into synchronization can be applied in such other scenarios. For example, the UE 102 may perform a UE-initiated deregistration 130A after transitioning from LTE mode to 5G mode without having previously registered with the 5G network. Similarly, the UE 102 may perform a UE-initiated deregistration 130A after reregistering with a 5G CN without having an intervening LTE session between the initial 5G session and the subsequent 5G session.

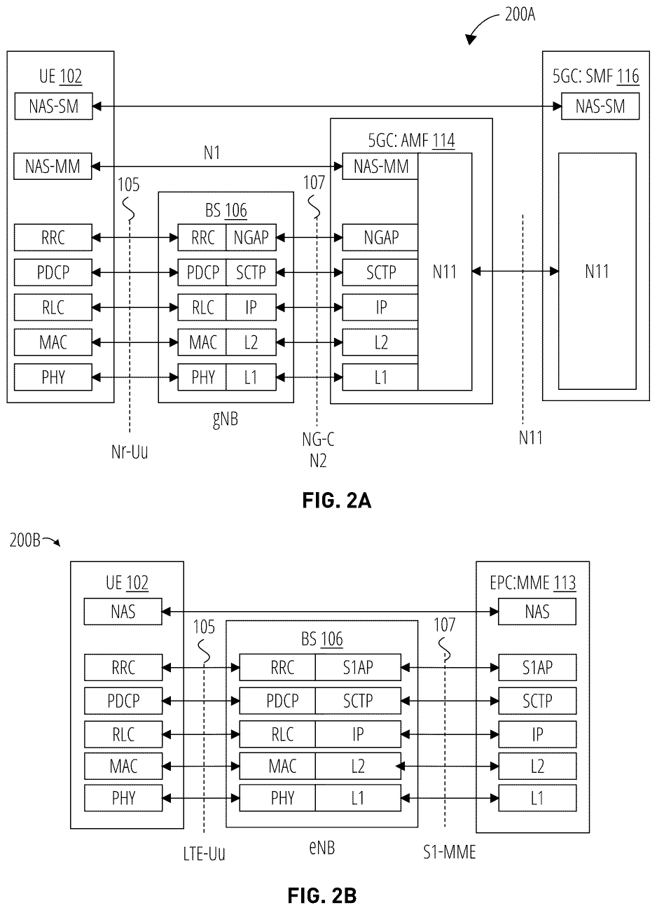

FIG. 2A is a block diagram illustrating an example control plane protocol stack in which the example wireless communication system 100 of FIG. 1A is a 5th generation system (5GS). FIG. 2A shows the control plane protocol stack 200A for the UE 102, the BS 106, and CN 110 entities such as the AMF 114 and the SMF 116. The 5G access network can include 5G NR (where the BS 106 is referred as a gNB) or EUTRA (where the BS 106 is referred to as an eNB).

The protocol layers between the UE 102 and the BS 106 include a physical (PHY) sub-layer that provides transport channels. A medium access control (MAC) sub-layer provides logical channels for a radio link control (RLC) sub-layer. The RLC sublayer in turn provides data transfer services to the PDCP sublayer. The PDCP sublayer in turn can provide data transfer services to a radio resource control (RRC) sublayer. For a 5GC, the protocol layers between the BS 106 and the CN 110 include a layer 1 (L1) sub-layer, layer 2 (L2) sub-layer, an Internet protocol (IP) sub-layer, Stream Control Transmission Protocol (SCTP) sub-layer, and Next Generation Application Protocol (NGAP) sub-layer. The AMF 114 and the SMF 116 can implement any variety of protocol layers (shown as N11) to manage communication via the N11 interface between them.

Aspects of this disclosure are related to the NAS communications between the UE 102 and the core network (such as a 5GC). For example, the UE 102 and the CN 110 communicate registration messages, authentication messages, deregistration messages, and SMC 140 messages via the NAS layer. Generally speaking, a NAS protocol manages the UE's mobility, session, and control plane signaling between the UE 102 and the CN 110, transparent to any 5G access network node (e.g., BS 106). In some aspects, the CN 110 implements various discrete control plane functions (shown as the AMF 114 and the SMF 116). Together the AMF 114 and the SMF 116 can implement portions of the NAS layer. The AMF 114 can provide mobility management (MM) aspects of the NAS layer while the SMF 116 can provide SM aspects of the NAS layer. The UE 102 communicates to the SMF 116 via NAS messages that are first sent to the AMF 114. The AMF 114 is responsible for managing the UE's mobility and connection to the CN 110. Also, any upper layer control signals can be delivered over the NAS layer between the AMF 114 and the UE 102, which is also called NAS-MM layer. The SMF 116 is responsible for managing PDU sessions, and a UE 102 can be associated with one or more SMFs 116 at the same time. The NAS protocol between the UE 102 and the SMF 116 is also called NAS-SM layer. The AMF 114 and the UE 102 communicate with each other via a logical interface referred to as the N1 control interface. The N1 control interface is a logical interface that traverses the Uu interface 105 (Nr-Uu when the BS 106 is a gNB) and the S1/NG interface 107 (sometimes referred to as the NG-C or N2 interface in a 5GC).

FIG. 2B is a block diagram illustrating an example control plane protocol stack in which the example wireless communication system 100 of FIG. 1A is a 4th generation system evolved packet system (EPS). The control plane protocol stack 200B of the EPS is similar to the control plane protocol stack 200A described with reference to FIG. 2A. Some nomenclature differences between FIG. 2B and FIG. 2A include: the BS 106 is shown as a EUTRA base station (eNB), the Uu interface 105 is labeled as an LTE-Uu interface, and the S1/NG interface 107 is referred to as an S1-MME interface. In the EPS, the MME 113 serves as a single endpoint for the NAS protocol in the core network. The MME 113 is responsible for both mobility management and session management aspects, although SM related protocols are assumed to be positioned above MM related protocols.

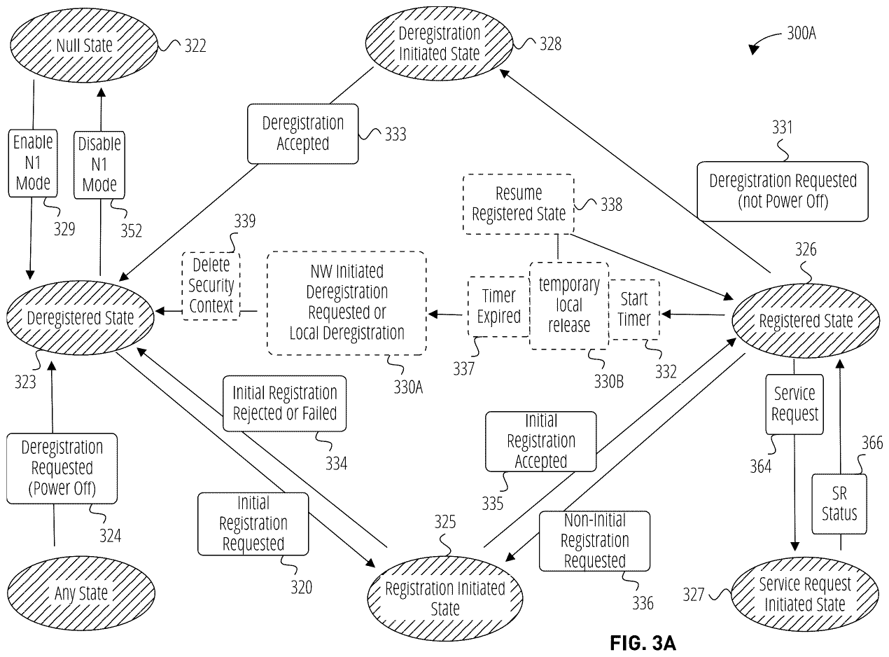

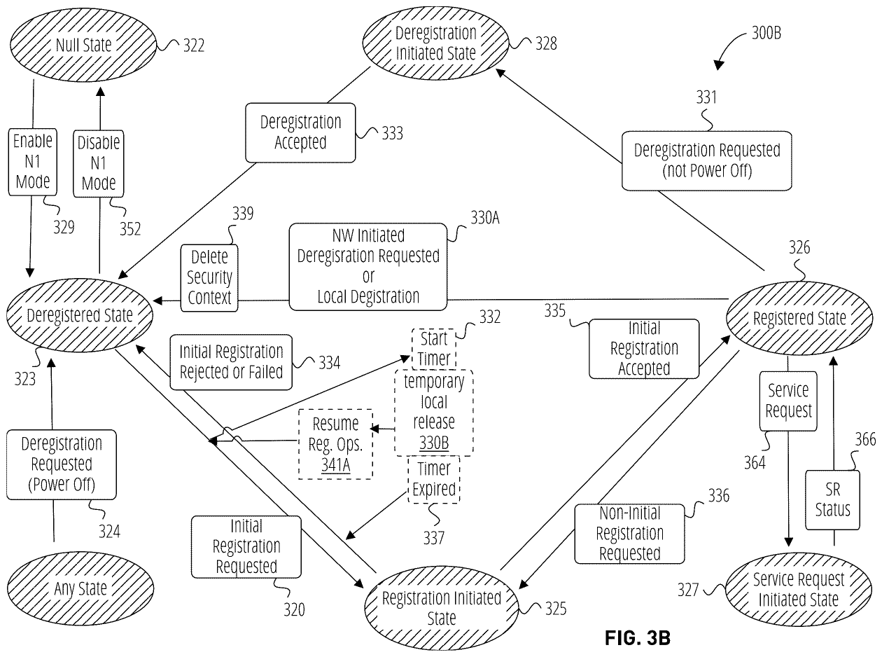

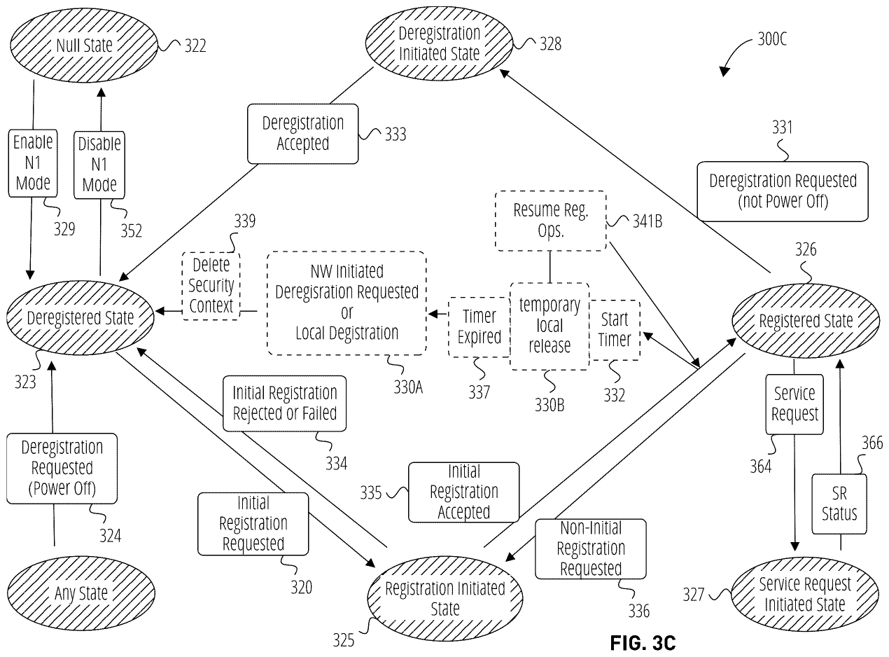

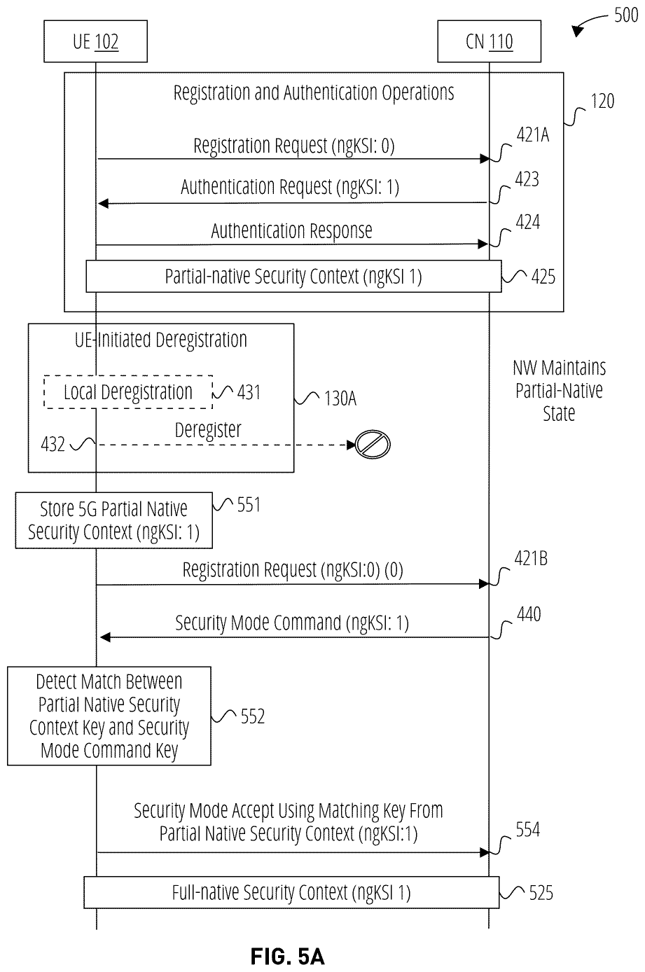

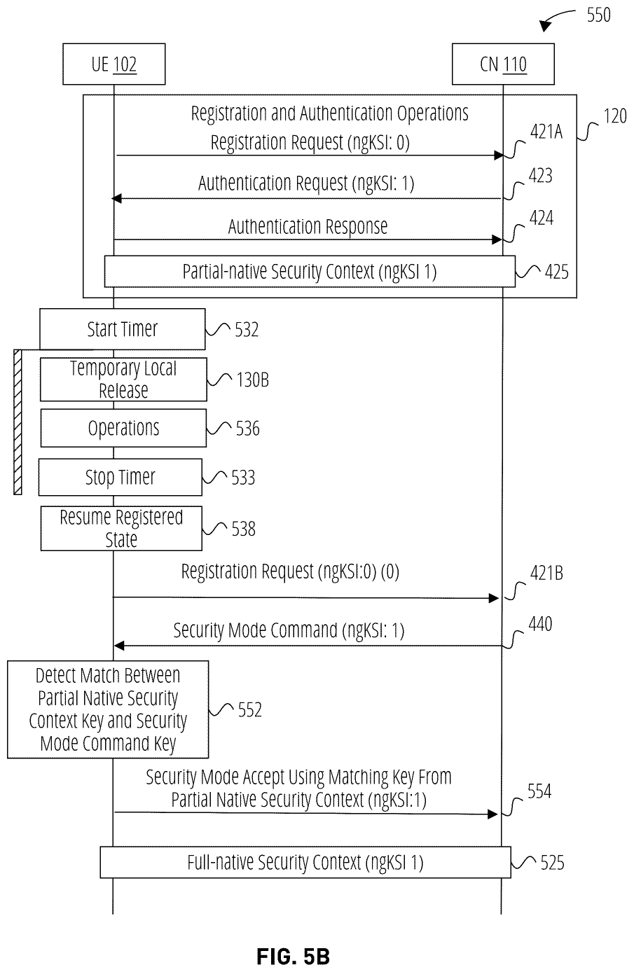

FIG. 3A is a state diagram 300A illustrating various UE registration states and a temporary local release during a registered state. The state diagram 300A is adapted from 3GPPP Technical Specification (TS) 24.501, FIG. 5.1.3.2.1.1.1. The discussion of FIG. 3A will assume that a UE (e.g., UE 102) is initially in the deregistered state 323 (e.g., 5GMM-DEREGISTERED) with respect to a core network (e.g., CN 110) and is operating in 5G mode. From the deregistered state 323, the UE may enter a null state 322 (e.g., 5GMM-NULL) or a registration initiated state 325 (e.g., 5GMM-REGISTERED-INITIATED). For example, the UE enters the null state by disabling N1 (5G) mode 352. From the null state 322, the UE can enable N1 mode 329 to return to the 5G deregistered state 323. The UE can enter the registration initiated state 325 when the UE communicates (or attempts to communicate) an initial registration request 320 to the CN. If the CN rejects the initial registration request or the registration attempt fails 334, the UE returns to the deregistered state 323. If the CN accepts the initial registration 335, the UE enters the registered state 326 (e.g., 5GMM-REGISTERED).

From the registered state, the UE may transition to a service request initiated state 327 (e.g., 5GGMM-SERVICE-REQUEST-INITIATED), a deregistration initiated state 328 (e.g., 5GMM-DEREGISTERED-INITIATED), registration initiated state 325, or the deregistered state 323. The UE may transition to the service request initiated state 327 by issuing a service request 364 to the CN. The UE receives a service request status 366 indicating whether the service request was accepted or rejected. The UE returns to the registered state when the service request status 366 is received.

The UE may transition back to the registration initiated state 325. In this situation, the UE may retry registration (e.g., a non-initial registration request 336) with the CN one or more times. If a non-initial registration is successful, the UE returns to the registered state 326. The UE may transition from the registration initiated state 325 to the deregistered state 323 if the non-initial registration request fails or after a predetermined number of retries have failed.

The UE may transition from the registered state 326 to the deregistration initiated state 328 after communicating a deregistration request 331 to the CN. The UE communicates a deregistration request 331 to the CN when the UE wishes to detach from the network, but will remain powered on. The UE may transition directly to the deregistered state 323 when requested to do so by the network (e.g., a network-initiated deregistration) or when the UE performs a local deregistration 330A (e.g., a UE-initiated deregistration). When the UE receives a deregistration accepted 333 indication from the CN, the UE transitions to the deregistered state 323.

While in the registered state 326, the UE may perform a temporary local release 330B when performing maintenance operations such as software updates, shifting to a different SIM card, radio link failure recovery, and the like. The term “temporary local release” can be replaced with any suitable term (such as maintenance state, paused registration state, registration suspended state) that is associated with the UE performing operations that does not require entering the deregistered state 323, even though the operations might prevent NAS communication between the UE and the CN. As part of the temporary local release, the UE starts a timer (shown at block 332). The timer is referred to as “timer” for brevity in this disclosure, but may be referred to by other terms, such as temporary local release timer, maintenance operations timer, timer Txxxx (where “xxxx” can be any number), or any other term that refers to a timer started as part of a temporary local release. If the maintenance operations are completed before the timer expires 337, the UE resumes 338 the registered state 326. In some implementations, when the UE resumes the registered state 326, the UE stops (or disables) the timer (that was started in block 332). If the maintenance operations do not complete before the timer expires, the UE transitions to block 330A and performs a local deregistration before proceeding to the deregistered state 323. The local deregistration can include deleting a previous security context 339. In some implementations, the UE may perform security context synchronization operations (not shown in FIG. 3A) which, if successful, returns the UE to the registered state 326.

In addition to the state transitions discussed above, the UE may transition from any of the states to the deregistered state 323 in the event that the UE issues a deregistration request 324 when powering off. The state transitions described above are examples, and other state transitions related to registration or other UE and CN functions may exist. The techniques of the disclosure may be applied to such other state transitions.

FIG. 3B is a state diagram 300B illustrating various UE registration states and a temporary local release prior to a registration initiated state. The state diagram 300B is similar to FIG. 3A, state diagram 300A. The difference between FIG. 3A and FIG. 3B relates to the timing when the UE performs a temporary local release to perform maintenance operations. In FIG. 3B, in some aspects, the UE performs a temporary local release 330B prior to transitioning to the registration initiated state 325. The UE performs a temporary local release 330B during initial registration requested 320 operations to perform maintenance operations. The UE starts a timer 332 and initiates the maintenance operations. If the UE finishes the maintenance operations before the timer expires 337, the UE resumes 341A the registration operations to transition to the registration initiated state 325. If the timer expires prior to completing the maintenance operations, the UE may transition back to the deregistered state 323.

FIG. 3C is a state diagram 300C illustrating various UE registration states and a temporary local release prior to a registered state. The state diagram 300C is similar to FIG. 3A, state diagram 300A. As with FIG. 3B, the difference between FIG. 3A and FIG. 3C relates to the timing when the UE performs a temporary local release to perform maintenance operations. In some aspects, the UE performs a temporary local release 330B to perform maintenance operations prior to entering the registered state 326. For example, the UE starts a timer 332 and initiates the maintenance operations. If the UE finishes the maintenance operations before the timer expires 337, the UE resumes 341B the registration operations to transition to the registered state 326. If the timer expires prior to completing the maintenance operations, the UE may transition back to the deregistered state 323.

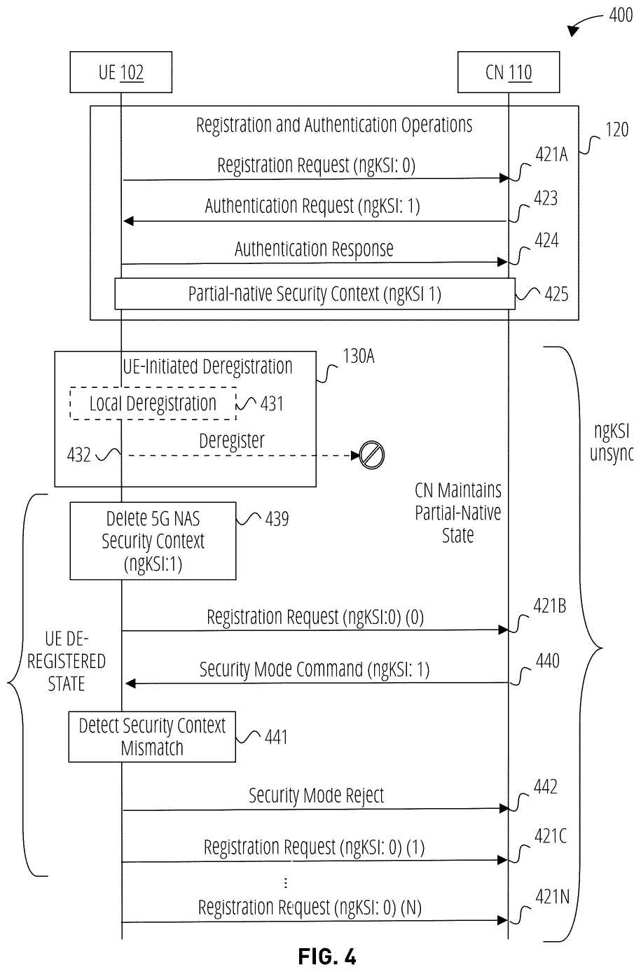

FIG. 4 is a communication signaling diagram 400 illustrating example operations in which a UE attempts to reregister with a CN following a local deregistration. In some cases, for the sake of illustration clarity, various acknowledgements for the messages illustrated in FIG. 4 are not shown and may be implemented to ensure reliable operations for processing UE registration requests.

At operation 421A, the UE 102 initiates the registration and authentication operations 120 by transmitting a registration request to the CN 110. The registration request includes a first key set identifier, referred to as ngKSI 0, that identifies a first security context. In some aspects, ngKSI 0 may be obtained from a non-current full-native security context created during a previous 5G communication session with the CN. In some aspects, ngKSI 0 is obtained from a mapped security context from a previous LTE communications session. At operation 423 the CN 110 responds with an authentication request. The authentication request includes a new key set identifier, referred to as ngKSI 1, that identifies a second security context. At operation 424, the UE 102 transmits an authentication response. After operations 421A, 423, and 424, both the UE 102 and the CN 110 maintain a partial-native security context 425 that is identified by ngKSI 1. In addition, the UE 102 might maintain a non-current full-native security context and/or a mapped security context.

After registration and authentication operations 120 and prior to completion of security mode control, the UE performs a UE-initiated deregistration 130A. In some aspects, the UE 102 performs a local deregistration 431. Because the deregistration is local to the UE 102, the CN 110 is not aware of the deregistration. In some aspects, at operation 432, the UE transmits a deregistration request towards the CN 110. However, in the example of FIG. 4, the CN 110 does not receive the request, perhaps because the UE 102 is in a poor communication environment. Because the CN 110 does not receive the deregistration request, the CN 110 is unaware of the UE 102's deregistration state.

At block 439, per existing specifications related to UE deregistration, the UE 102 deletes the partial native security context 425. Additionally, the UE deletes any mapped security contexts that it may have maintained that were mapped from an LTE security context from a previous LTE session. The CN 110, unaware that the UE has deregistered, maintains the partial-native security context 425 including ngKSI 1 and thus experiences “ngKSI unsync,” which is lack of matching ngKSI values between the UE and the CN.

At operation 421B, the UE 102 again attempts to register with the CN 110 by transmitting a second registration request to the CN 110. See FIG. 3A element 336. Like the first registration request, the UE 102 specifies ngKSI 0 in second registration request of operation 421B, where ngKSI 0 identifies a non-current security context or a mapped security context.

At operation 440, the CN 110, assuming that the UE 102 is still in a registered state, transmits a security mode command to initiate security mode control to transform the partial-native security context 425 to a full-native security context. The security mode command includes ngKSI 1 to indicate the partial-native security context 425.

At block 441, the UE 102 detects a mismatch in security contexts being used by the UE 102 and the CN 110. For example, the UE 102 can determine that the UE 102 is not maintaining any security contexts for the key set identifier specified by the security mode command, ngKSI 1 (the UE 102 having deleted the partial-native security context 425 at block 439).

At operation 442, the UE 102 transmits a security mode reject message to the CN 110.

At operations 421C-421N, the UE 102 may reattempt registration with the CN 110 by transmitting one or more registration requests to the CN 110. In some aspects, the UE 102 retries registration up to five times. As was the case at operation 421B, in the operations 421C-421N, the UE 102 specifies ngKSI 0 in the registration request. The CN 110 still maintains partial-native security context 425 with ngKSI 1 as the security context associated with the UE 102, and rejects the attempts by the UE 102 to register using ngKSI 0.

When the CN 110 receives multiple failed attempts to register, the CN 110 might transmit a request to the UE 102 that the UE defer further registration attempts for a period of time, for example, twelve minutes. During this period, the UE 102 may be unable to access any 5G services. The UE 102 might face delays in accessing a 5G network and network services because of the time consumed by repeated failed registration attempts and the potential twelve minute deferral of further registration attempts. This delay can lead to user frustration and dissatisfaction with the UE and/or the network provider.

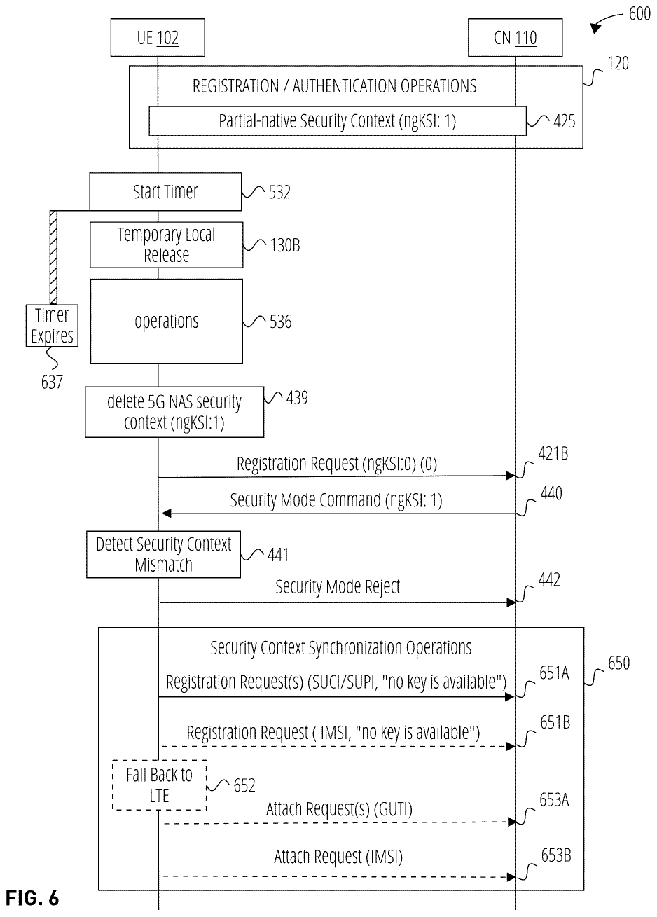

FIG. 5A, FIG. 5B, and FIG. 6 through FIG. 9 are signaling diagrams illustrating examples of various techniques associated with performing UE-initiated security context synchronization operation(s) 150 (FIG. 1A). The techniques described with respect to FIG. 5A, FIG. 5B, and FIG. 6 through FIG. 9 can facilitate the UE avoiding unnecessary synchronization operations and/or decrease the time it takes for a UE 102 to synchronize security context with a CN 110. These techniques can reduce the time it takes for the UE 102 to successfully register and perform security mode control following expiration of a timer for a temporary local release 130B or a UE-initiated deregistration 130A that the CN 110 is not aware of. The sequence diagrams of FIG. 5A, FIG. 5B, and FIG. 6 through FIG. 9 show NAS messaging between the UE 102 and the CN 110. Here, the functions and messages of the CN 110 can include any type of CN Node, such as an AMF, SMF, or MME, or a new entity for a later generation of a wireless communication system.

Each of the signaling diagrams of FIG. 5A, FIG. 5B, and FIG. 6 through FIG. 9 begin in the same way, that is, with operations 421A, 423 and 424 of registration and authentication operations 120 which create a partial-native security context 425. Operations 421A, 423, and 424 are not shown in FIG. 6 through FIG. 9. The description of these operations has been provided above with respect to FIG. 4, and will not be repeated in FIG. 5A, FIG. 5B, and FIG. 6 through FIG. 9. As was the case with FIG. 4, in some cases, for the sake of illustration clarity, various acknowledgements for the messages illustrated in FIG. 5A, FIG. 5B, and FIG. 6 through FIG. 9 are not shown and may be implemented to ensure reliable operations for processing UE registration requests.

FIG. 5A is a communication signaling 500 diagram illustrating example operations in which a UE synchronizes a security context with a CN based on a partial native security context key that was stored by the UE. In the example shown in FIG. 5A, after the UE 102 performs a UE-initiated deregistration 130A, at block 551, the UE 102 stores (e.g., saves, maintains, etc.) the partial-native security context 425. This is different from existing specifications, such as that shown in the example of FIG. 4 where the UE 102 deletes the partial-native security context.

Operation 421B and 440 occur as described with respect to FIG. 4.

At block 552, however, the UE 102 detects that the UE 102 has a security context (partial-native security context 425 stored at block 551) including a key set identifier that matches the key set identifier in the security mode command (ngKSI 1). At operation 554, the UE 102 transmits a security mode accept message to the CN 110 that includes the matching security key set identifier ngKSI 1. The security mode control 140 is successfully completed at this point and the partial-native security context 425 is transformed into full-native security context 525. At this point, the UE 102 and the CN 110 can securely communicate with one another using the encryption, authentication, and integrity checking parameters of full-native security context 525.

As noted above, storing 551 the partial-native security context 425 differs from existing systems and specifications. For example, according to existing specifications, when the UE or the AMF moves from 5GMM-REGISTERED to 5GMM-DEREGISTERED state, if the current 5G NAS security context is a mapped 5G NAS security context and a non-current full native 5G NAS security context exists, then the non-current 5G NAS security context shall become the current 5G NAS security context. Furthermore, the UE and the AMF shall delete any mapped 5G NAS security context or partial native 5G NAS security context. The techniques described in FIG. 5A differ from existing systems and specifications in that, as an implementation option, the UE may store the partial native 5G NAS security context if the UE moves from 5GMM-REGISTERED to 5GMM-DEREGISTERED state due to (local) deregistration.

The techniques shown in FIG. 5A have the potential technical advantage that the UE 102 can access a 5G network and its services after a local deregistration faster and with potentially less resource usage than is the case with existing systems. For example, the techniques shown in FIG. 5A that store the partial-native security context 425 after a local deregistration facilitate the UE 102 to avoid the repeated attempts at registration of operations 421C-421N shown in FIG. 4 and the potential for a lengthy (e.g., twelve minute) deferral of further registration attempts.

FIG. 5B is a communication signaling sequence diagram 550 illustrating example operations in which a UE 102 maintains synchronization of a security context with a CN 110 when performing maintenance operations. As described above, the UE 102 and the CN 110 complete registration and authentication operations 120 thereby creating a partial-native security context 425.

Following the registration and authentication operations 120, the UE 102 may determine to perform maintenance operations 536. For example, the UE 102 may update software on the UE, perform a frequency switch (e.g., for UEs supporting dual SIM dual standby (DSDS) radio frequency switching), or attempt recovery in the event of a radio link failure.

At block 532, the UE 102 starts a timer. See FIG. 3A element 332. Generally speaking, the UE 102 may set the timer to a value that indicates the time “allowed” for the UE to complete the maintenance operations before the CN 110 determines that the UE 102 has dropped the communication session between the UE 102 and the CN 110. In some aspects, the UE sets the timer value based on the residual re-TX timer value of the on-going procedure (e.g., a residual T3410 timer value). For example, the UE may set the timer value to one of:
a minimum timer value as the residual re-TX timer (e.g., a timer value based on the residual re-TX time value for an on-going procedure such as the residual TX3410 timer value)
a maximum timer value based on the retry times (e.g., an attach attempt counter is set to five as specified in TS 24.301)
a residual re-TX timer value (optionally adding more time for retries)

In some aspects, the UE sets the timer value based on the expected/on-going network re-TX timer value.
an expected time for the CN to initiate a security mode control (SMC) procedure (e.g., with re-TX timer T3460, and retries up to five times in total as specified in TS 24.301).
a minimum timer value as the network residual re-TX timer
a maximum timer value based on the retry times (e.g., an SMC procedure that can be retried for up to five times)
a residual network re-TX timer value (optionally adding more retries)

In some aspects, the UE sets the timer as a time value of the UE re-TX timer value or the network re-TX timer value.

At block 130B, the UE 102 performs a temporary local release. See FIG. 3A element 330B. The UE maintains the partial-native security context (ngKSI: 1) during a temporary local release. The UE 102 can use the temporary local release to optimize resources during the maintenance operations while avoiding unnecessary signaling between the UE 102 and the CN 110.

In the example of FIG. 5B, the maintenance operations 536 complete prior to the expiration of the timer. At block 533, the UE optionally stops (or disables) the timer started at block 532. At block 538, the UE 102 resumes the registered state. See FIG. 3A element 338.

At operation 440, the CN 110 transmits a security mode command to initiate security mode control to transform the partial-native security context 425 to a full-native security context. The security mode command includes ngKSI 1 to indicate the partial-native security context 425.

Elements 552, 554, and 525 proceed as previously described with respect to FIG. 5A, and the UE 102 and the CN 110 can securely communicate with one another using the encryption, authentication, and integrity checking parameters of the full-native security context 525.

FIG. 6 is a communication signaling diagram 600 illustrating example operations in which a UE synchronizes a security context with a CN using a SUCI and indicating that no key is available. The example shown in FIG. 6 differs from that shown in FIG. 5B in that the timer expires 637 before completion of the maintenance operations 536. At block 439, the UE 102 deletes the partial-native security context 425 as described above with respect to FIG. 4. Additionally, the UE deletes any mapped security contexts that it may have maintained that were mapped from an LTE security context from a previous LTE session. Meanwhile, the CN 110 maintains the partial-native security context 425 including ngKSI 1, as described with respect to FIG. 4, and experiences ngKSI unsync.

Through operations 421B, 440, 441, and 442, the UE 102 performs the same or similar operations as shown and described above with respect to FIG. 4. The example shown in FIG. 6 differs from the example of FIG. 4 in that after transmitting 442 the security mode reject message, the UE 102 performs security context synchronization operations 650 instead of repeating the registration request at operation 421B. The security context synchronization operations 650 may be an implementation of the UE-initiated security context synchronization operation(s) 150 (FIG. 1A). The operations of block 650 include operation 651 and optionally operations 651B, 652, 653A, and 653B. Responses to these operations are not shown and may be implemented to ensure reliable operations for processing security context synchronization operations 650.

At operation 651, the UE 102 transmits one or more registration requests to the CN 110. The registration requests of operation 651 differ from the registration requests of operations 421A and 421B in that the registration requests of operation 651 include an indication that “no key is available” for the registration request rather than supplying ngKSI 0 as was done for prior registration requests 421A and 421B. Additionally, the UE 102 includes a SUCI or a SUPI in the registration requests. The SUPI is an identifier associated with a network subscriber that uniquely identifies the subscriber, in this example, the user of UE 102. The SUCI is an encryption of the SUPI using a public key of the user's home network and is used to protect the security and privacy of the subscriber in wireless communications.

The UE 102 includes the indication that “no key is available” in the one or more registration requests of operation 651 to trigger the CN 110 to perform AKA procedures with the UE 102. The AKA procedures, when initiated, synchronize the security contexts between the UE 102 and CN 110 such that the UE 102 and the CN 110 use the same ngKSI.

If none of the one or more registration requests of operation 651 are successful, at operation 651B, the UE 102 may transmit a registration request that again indicates that “no key is available.” In this registration request, the UE 102 includes an international mobile subscriber identity (IMSI) instead of the SUCI or SUPI. The IMSI, like the SUPI, is a unique identifier of a network subscriber, and can be used to authenticate and authorize a UE when it connects to the network. While using the IMSI is a valid fallback for authentication, using SUCI is more secure. Thus, this fallback is intended for situations where SUCI-based procedures fail or are unsupported.

If the registration request of operation 651B is not successful, at block 652, the UE 102 falls back to LTE mode. For example, the UE can disable N1 mode.

After falling back to LTE, at operation 653A, the UE transmits, to the CN 110, one or more LTE attach requests that include a globally unique temporary identity (GUTI). The GUTI is a temporary identifier associated with the UE that is generated by the CN 110 (e.g., FIG. 1A, MME 113 or AMF 114). Because the GUTI is temporary and changing, it is not associated with any particular subscriber or UE, thereby improving the security and privacy of the user of the UE.

If none of the one or more attach requests of operation 653A are successful, at operation 653B, the UE 102 may transmit an attach request that includes the IMSI associated with the UE 102.

The techniques shown in FIG. 6 have a potential technical advantage similar to that shown and described with respect to FIG. 5A. The UE 102 can access a 5G network and its services after a temporary local release and maintenance operations faster and with potentially less resource usage than is the case with existing systems. For example, the techniques shown in FIG. 6 avoid the repeated attempts at registration of operations 421C-421N shown in FIG. 4 that use an ngKSI that doesn't match any security context maintained by the CN 110, and further avoid the potential for a lengthy (e.g., twelve minute) deferral of further registration attempts.

Block 650 described above refers to implementations in which the UE 102 falls back to an LTE RAT from a 5G RAT. In other implementations, the UE 102 may be operating using a 6G RAT and at block 652, may fall back to a 5G RAT. The techniques disclosed herein may be applied to these and other implementations using different RATs.

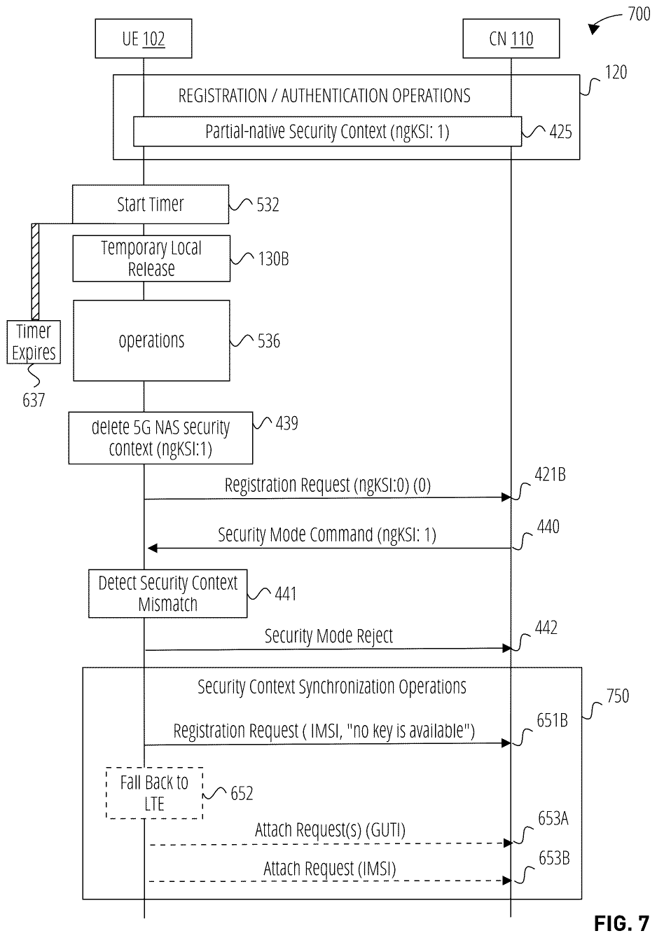

FIG. 7 is a communication signaling diagram 700 illustrating example operations in which a UE synchronizes a security context with a CN using an IMSI and indicating that no key is available. The techniques of FIG. 7 are the same as or similar to those shown in FIG. 6 described above and can be used, for example, if the UE 102 does not support a SUCI or a SUPI. The security context synchronization operations 750 of FIG. 7 differ from the security context synchronization operations 650 of FIG. 6 in that security context synchronization operations 750 omit operation 651A that transmits one or more registration requests indicating the SUCI/SUPI and that no key is available. Instead, security context synchronization operations 750 start with operation 651B where the UE 102 transmits a registration request that includes the IMSI and an indication that no key is available.

If the registration request of operation 651B is unsuccessful, the UE 102 proceeds in the same manner as in security context synchronization operations 650. That is, the UE 102 falls back to LTE mode (block 652) and transmits one or more attach requests indicating the GUTI (operation 653A). If the one or more attach requests of operation 653A are unsuccessful, the UE 102 transmits an attach request indicating the IMSI (operation 653B).

The techniques shown in FIG. 7 have a potential technical advantage similar to that shown and described with respect to FIG. 6. The UE 102 can access a 5G network and its services after a temporary local release to perform maintenance operations faster and with potentially less resource usage than is the case with existing systems. For example, the techniques shown in FIG. 7, like those shown in FIG. 6, avoid the repeated attempts at registration of operations 421C-421N shown in FIG. 4 that use an ngKSI that doesn't match any security context maintained by the CN 110, and further avoid the potential for a lengthy (e.g., twelve minute) deferral of further registration attempts.

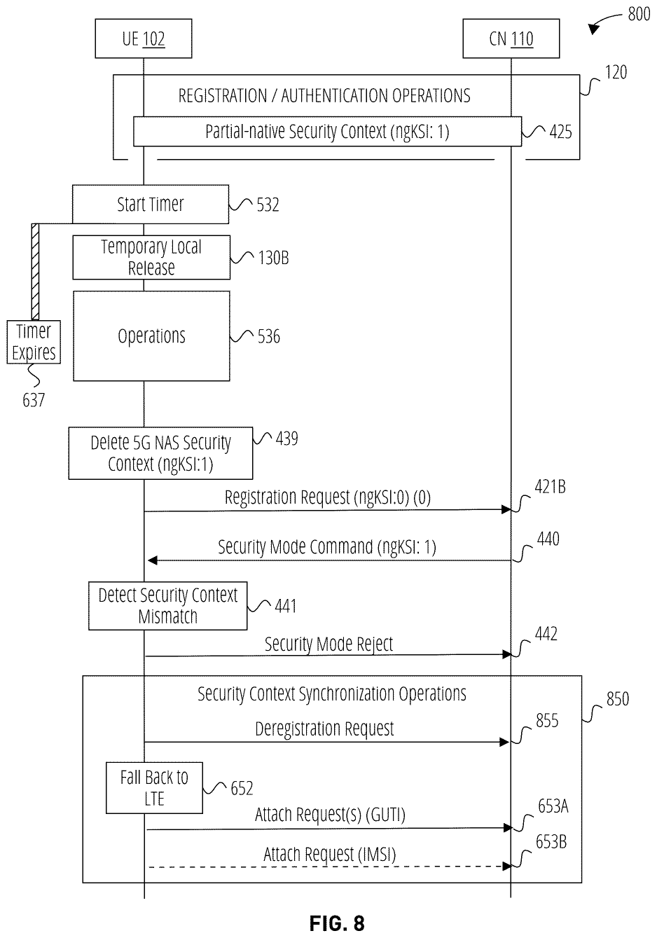

FIG. 8 is a communication signaling diagram 800 illustrating example operations in which a UE synchronizes a security context with a CN via a deregistration request. The techniques of FIG. 8 are the same as or similar to those shown in FIG. 7 described above. The security context synchronization operations 850 of FIG. 8 differ from the security context synchronization operations 750 of FIG. 7 in that security context synchronization operations 850 omit operation 751 that transmits one or more registration requests indicating the IMSI and that no key is available. Instead, security context synchronization operations 850 start with operation 855 where the UE 102 transmits a deregistration request to the CN 110. See FIG. 3A element 330A deregistration requested. The deregistration request of operation 855 may inform the CN 110 that the UE may be out of synchronization with the CN 110 because the UE did not complete maintenance operations 536 before the timer expired 637.

After operation 855, the UE 102 proceeds in the same manner as in security context synchronization operations 750. That is, the UE 102 falls back to LTE mode (block 652) and transmits one or more attach requests indicating the GUTI (operation 653A). If the one or more attach requests of operation 653A are unsuccessful, the UE 102 may transmit an attach request indicating the IMSI (operation 653B).

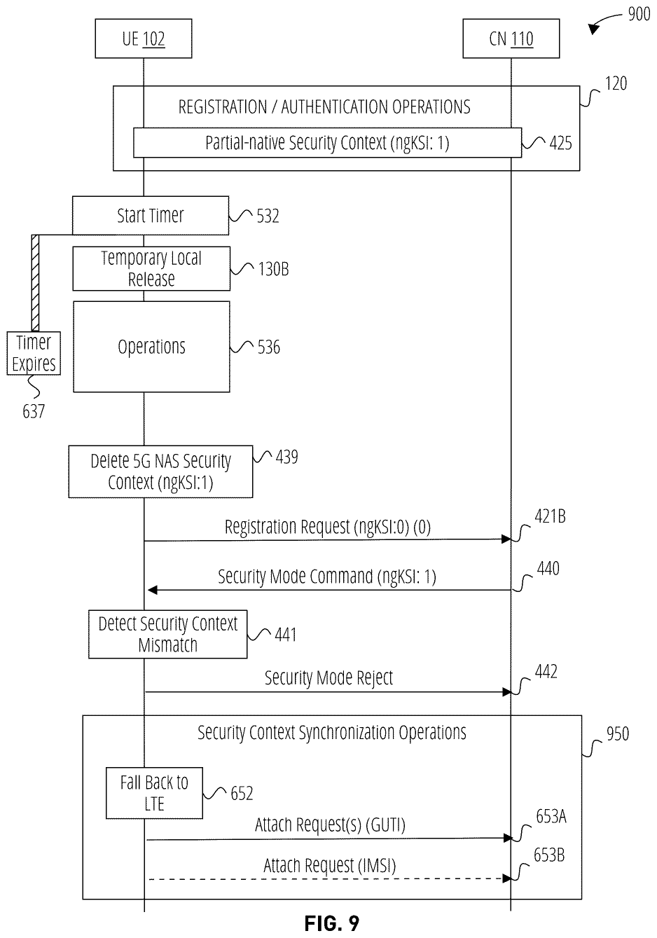

FIG. 9 is a communication signaling diagram 900 illustrating example operations in which a UE 102 falls back to LTE operation to synchronize a security context with a CN 110. The techniques of FIG. 9 are the same as or similar to those shown in FIG. 7 and FIG. 8 described above. The security context synchronization operations 950 of FIG. 9 differ from the security context synchronization operations FIG. 7 element 750 and security context synchronization operations FIG. 8 element 850 in that security context synchronization operations 950 omit both operation 651 and operation 751 that transmit one or more registration requests indicating that no key is available. Instead, security context synchronization operations 950 start with block 652 where the UE 102 falls back to LTE mode. The UE 102 then transmits one or more attach requests indicating the GUTI (operation 653A). If the one or more attach requests of operation 653A are unsuccessful, the UE 102 transmits an attach request indicating the IMSI (operation 653B).

The techniques described above with respect to FIG. 5A through FIG. 9 are not mutually exclusive, and can be combined in various ways. As one example, the deregistration request of FIG. 8, operation 855 can be added to any of security context synchronization operations 650, 750, or 950.

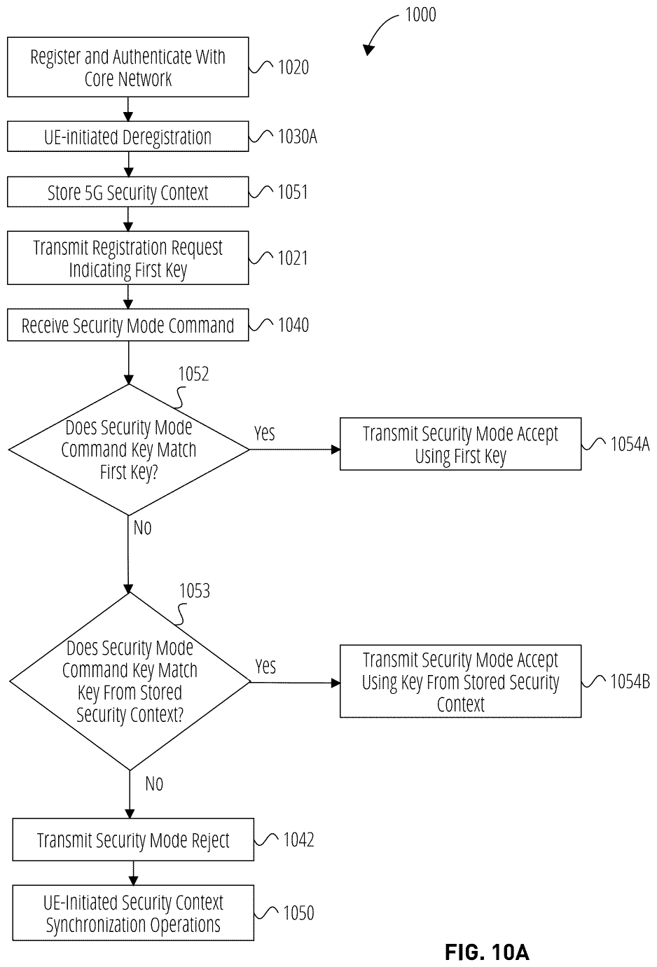

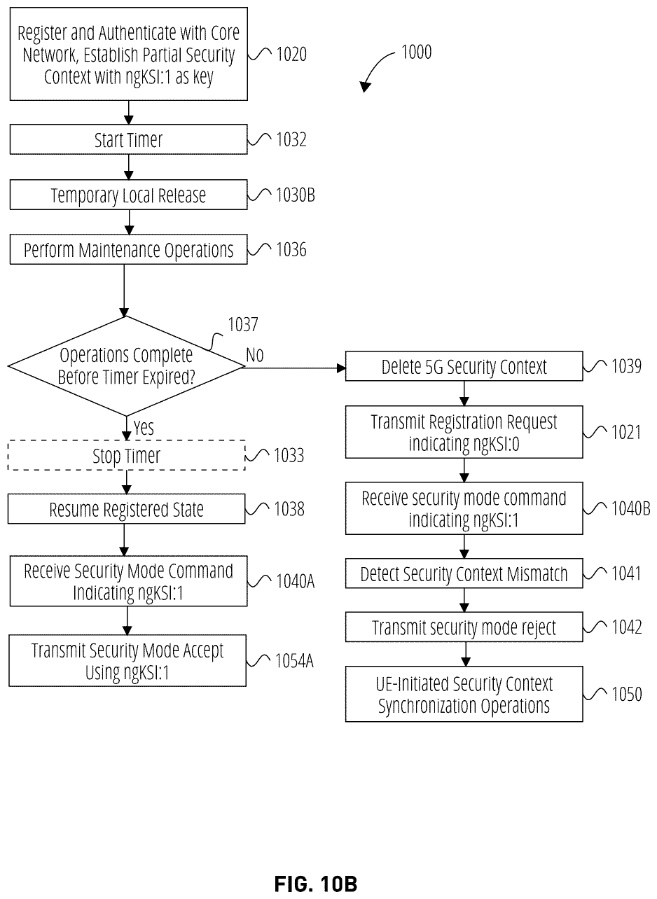

FIG. 10A is a flowchart diagram 1000 illustrating example operations in which a UE synchronizes a security context with a CN based on a partial native security context key that was stored by the UE. The operations may be performed, for example, by the UE 102 of FIG. 1A and FIG. 5A-FIG. 9.

At block 1020, and as described above with respect to FIG. 1A and FIG. 4-FIG. 9, operation 120, the UE registers and authenticates with a CN (e.g., a 5GC). The CN may be an implementation of CN 110 of FIG. 1A and FIG. 5A-FIG. 9. In some aspects, the UE initiates the registration by transmitting a registration request message that includes an ngKSI from a partial-native security context that was established during a previous 5G session with the CN. In some other aspects, the UE uses an ngKSI from a mapped security context that was established during a previous LTE session with the CN. In this flowchart diagram, the ngKSI included in the registration request message will be referred to as ngKSI_R.

The CN can respond to the registration request message from the UE by transmitting an authentication request. The CN may generate a new partial-native security context with a new ngKSI referred to as ngKSI_P. The CN includes ngKSI in the authentication request transmitted to the UE. The UE can respond to the authentication request and if the response is accepted, the UE and the CN both maintain a partial-native security context having a key set identifier of ngKSI_P.

At block 1030A, and as described above with respect to FIG. 1A and FIG. 4-FIG. 9, block 130A, the UE performs a UE-initiated deregistration. In some aspects, the UE performs a local deregistration without transmitting a deregistration request. In some aspects, the UE transmits a deregistration request that is not received by the CN. For example, the UE may have entered a poor communications environment that prevents UE 5G transmissions from being received by the CN.

At block 1051, and as further described above with respect to FIG. 5A, block 551, the UE stores the partial-native security context generated at block 1020. In some aspects, the UE stores the partial-native security context including ngKSI_P based on the local deregistration of block 1030A occurring before completion of security mode control.

At block 1021, and as described above with respect to FIG. 1A and FIG. 4-FIG. 9, operation 421B, the UE transmits a second registration request to the CN. The second registration request includes the first security key indicator ngKSI_R.

At block 1040, and as described above with respect to FIG. 1A and FIG. 4-FIG. 9, operation 440, the UE receives a security mode command from the CN. The security mode command includes a key set identifier referred to as ngKSI_SMC.

At decision block 1052, the UE compares the key set identifier received in the security mode command, ngKSI_SMC, with the first key set identifier, ngKSI_R. If the UE determines, based on the comparison, that the two key set identifiers match (“YES” branch of block 1052), e.g., ngKSI_R matches ngKSI_SMC, then at block 1054A, the UE transmits a security mode accept including ngKSI_R. If the two key set identifiers do not match (“NO” branch of decision block 1052), e.g., ngKSI_R does not match ngKSI_SMC, the UE proceeds to decision block 1053.

At decision block 1053, the UE compares the key set identifier received in the security mode command, ngKSI_SMC, with the key set identifier of the stored partial-native security context, ngKSI_P. If the two key set identifiers match (“YES” branch of decision block 1053), e.g., ngKSI_SMC matches ngKSI_P, then at block 1054B, the UE transmits a security mode accept message to the CN that includes the key set identifier from the stored partial-native security context ngKSI_P. If the two key set identifiers do not match (“NO” branch of decision block 1053), then at block 1042 the UE transmits a security mode reject to the CN.

FIG. 10B is a flowchart diagram illustrating example operations in which a UE maintains security context synchronization with a CN when performing maintenance operations. The operations may be performed, for example, by the UE 102 of FIG. 1A and FIG. 5B and FIG. 6-FIG. 9.

At block 1020, and as described above with respect to FIG. 1A and FIG. 4-FIG. 9, block 120, the UE registers and authenticates with a CN (e.g., a 5GC). The CN may be an implementation of CN 110 of FIG. 1A, FIG. 5A, FIG. 5B, and FIG. 6-FIG. 9. In some aspects, the UE initiates the registration by transmitting a registration request message that includes an ngKSI from a partial-native security context that was established during a previous 5G session with the CN. In some other aspects, the UE uses an ngKSI from a mapped security context that was established during a previous LTE session with the CN. In this flowchart diagram, the ngKSI included in the registration request message will be referred to as ngKSI_R.

The CN can respond to the registration request message from the UE by transmitting an authentication request. The CN may generate a new partial-native security context with a new ngKSI referred to as ngKSI_P. The CN includes ngKSI in the authentication request transmitted to the UE. The UE can respond to the authentication request and if the response is accepted, the UE and the CN both maintain a partial-native security context having a key set identifier of ngKSI_P.

The UE may determine to perform maintenance operations prior to further registration operations. As described above, such maintenance operations may include software updates, radio frequency switches for DSDM SIM cards, radio link failure recovery, and the like.

At block 1032, and as described above with respect to FIG. 5B and FIG. 6-FIG. 9, block 532, the UE starts a timer.

At block 1030B, and as described above with respect to FIG. 1A, FIG. 5B and FIG. 6-FIG. 9, block 130B, the UE performs a temporary local release. The temporary local release may free resources for the UE to use in performing the maintenance operations, and may reduce unnecessary communications with the CN.

At block 1036, and as described above with respect to FIG. 5B and FIG. 6-FIG. 9, block 536, the UE performs the maintenance operations.

At decision block 1037, the UE determines if the maintenance operations of block 1036 have completed prior to the expiration of the time started at block 1032. If the maintenance operations have completed prior to the expiration of the timer (“Yes” branch of block 1037), at block 1033, the UE optionally stops the timer started at block 1032. At block 1038, and as described at FIG. 5, block 538, the UE resumes the registered state.

At block 1040A, and as described above with respect to FIG. 5B and FIG. 6-FIG. 9, operation 440, the UE receives a security mode command from the CN to initiate security mode control to transform the partial-native security context generated at block 1020 to a full-native security context.

As described above with respect to FIG. 10A, block 1054A, the UE transmits a security mode accept including ngKSI_R. After the UE transmits the security mode accept, the security context of the UE matches the security context of the CN.

If the maintenance operations have not completed prior to the expiration of the timer (“No” branch of block 1037), at block 1039, the UE deletes the partial native 5G security context created as part of the registration and authentication operations of block 1020. The UE may also delete a mapped security context if one exists.

At block 1021, and as described above with respect to FIG. 1A and FIG. 4-FIG. 9, operation 421B, the UE transmits a second registration request to the CN. The second registration request includes the first security key indicator ngKSI_R.

At block 1040B, and as described above with respect to FIG. 1A and FIG. 4-FIG. 9, operation 440, the UE receives a security mode command from the CN. The security mode command includes a key set identifier referred to as ngKSI_SMC.

At block 1041, and as described above with respect to FIG. 4, block 441, the UE detects a mismatch between the security context of the UE and the security context of the CN. For example, the UE determines that the security key of the security context of the UE (e.g., ngKSI_R) does not match the security key of the CN (e.g., ngKSI_SMC)

At block 1042 the UE transmits a security mode reject to the CN.

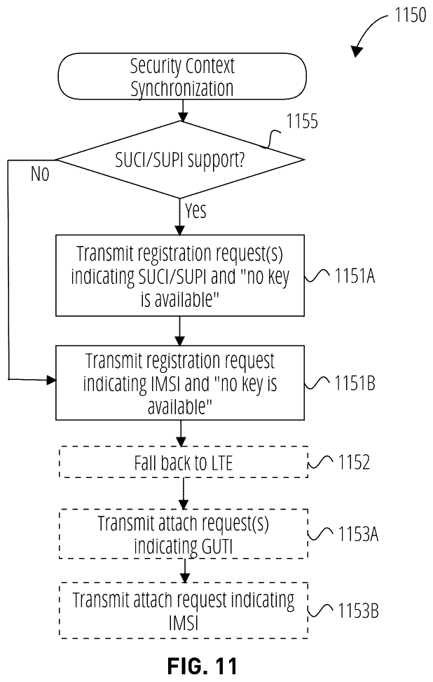

After rejecting the security mode command, at block 1050, the UE may initiate security context synchronization operations. FIG. 11-FIG. 13 below are flowcharts that provide details regarding the security context synchronization operations of block 1050.

FIG. 11 is a flowchart diagram 1150 illustrating example operations in which a UE synchronizes a security context with a CN by indicating that no key is available after a local deregistration. The operations may be performed, for example, by the UE 102 of FIG. 1A and FIG. 5A-FIG. 9.

As described above with respect to FIG. 10A, block 1020, the UE registers and authenticates with the network. After registration and authentication, the UE maintains a partial-native security context having a key set identifier ngKSI 1 and a non-current full-native security context (and/or a mapped security context) having a key set identifier ngKSI 0 used during the initial registration request of block 1020.

At decision block 1155, the UE determines if the UE supports the use of SUCI/SUPI to identify the UE. If the UE supports the use SUCI/SUPI (“YES” branch of decision block 1155), then at block 1151A, and as described above with respect to FIG. 6, operation 651, the UE transmits one or more registration requests including the SUCI/SUPI to the CN. The one or more registration requests include an indication that “no key is available” to attempt to trigger the CN to perform AKA procedures with the UE again. Repeating the AKA procedures will bring the security contexts of the UE and the CN back into synchronization. If the UE does not support the use of SUCI/SUPI to identify the UE (“NO” branch of decision block 1155), the UE proceeds to block 1151B.

The operations of block 1151B may be performed if the UE does not support SUPI/SUCI or if the registration requests of block 1151A are unsuccessful in triggering the CN to perform AKA operations to bring the security contexts of the UE and the CN back into synchronization. At block 1151B, and as described above with respect to FIG. 6A and FIG. 7, operation 651B the UE transmits a registration request including the IMSI to identify the UE. The registration request, like the one or more registration requests of block 1151A, includes an indication that “no key is available” to attempt to trigger the CN to perform AKA procedures with the UE again.

If the registration requests of blocks 1151A and 1151B are unsuccessful at triggering the CN to perform AKA procedures with the UE, then at block 1152, and as described above with respect to FIG. 6A-FIG. 9 block 652, the UE falls back (e.g., transitions to) operating in LTE mode.

At block 1153A, and as described above with respect to FIG. 6A-FIG. 9, operation 653A, the UE transmits one or more attach requests to the CN to connect with the CN in LTE mode. The one or more attach requests include the GUTI of the UE.

If the one or more attach requests of block 1153A are not successful, then at block 1153B, and as described above with respect to FIG. 6A-FIG. 9, operation 653B, the UE transmits an attach request to the CN that replaces the GUTI with the IMSI of the UE.

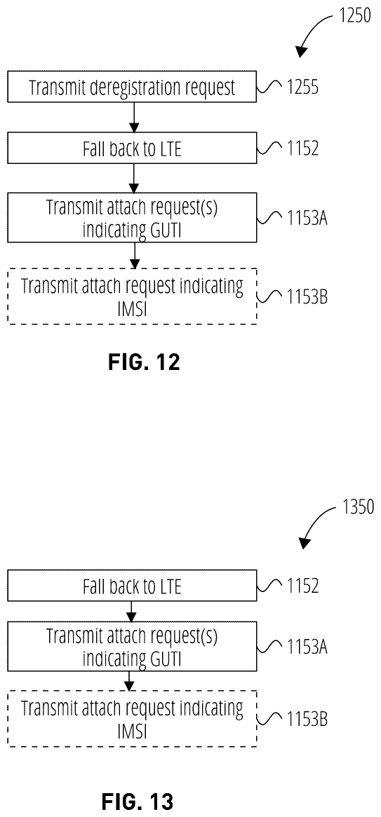

FIG. 12 is a flowchart diagram 1250 illustrating example operations in which a UE synchronizes a security context with a CN via a deregistration request. The operations may be performed, for example, by the UE 102 of FIG. 1A, FIG. 5A, FIG. 5B and FIG. 6-FIG. 9.

At block 1255, and as described above with respect to FIG. 8, operation 855, the UE transmits a deregistration request to the CN. By informing the CN that the UE has deregistered, the UE can put the CN into a registration state with respect to the UE that can make it easier for the UE and the CN to synchronize security contexts.

After deregistration, the UE falls back to LTE mode of operation (block 1152) and transmits attach requests at blocks 1153A and 1153B. Blocks 1152, 1153A, and 1153B which have been described above with respect to FIG. 11.

FIG. 13 is a flowchart diagram 1350 illustrating example operations in which a UE falls back to LTE operation to synchronize a security context with a CN. The operations may be performed, for example, by the UE 102 of FIG. 1A and FIG. 5A-FIG. 9. The operations of FIG. 13 are the same as those of FIG. 12, with the exception that in flowchart diagram 1350, the UE does not transmit a deregistration request prior to performing the operations of blocks 1152, 1153A, and 1153B.

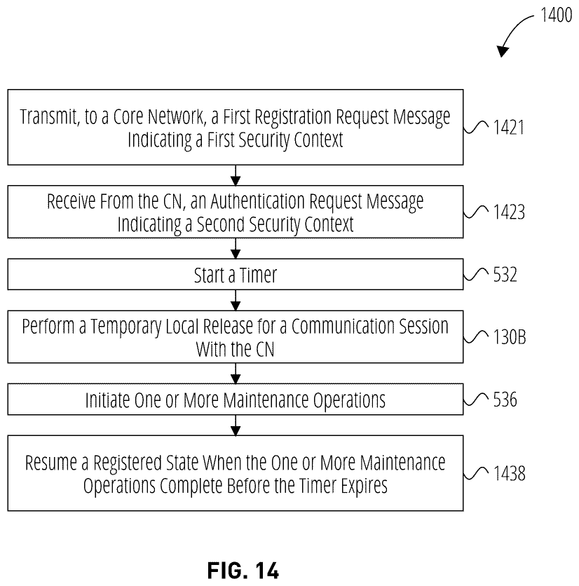

FIG. 14 is a flowchart diagram illustrating example operations 1400 in which a UE maintains security context synchronization with a CN when performing maintenance operations. The operations may be performed, for example, by the UE 102 of FIG. 1A, FIG. 5A, FIG. 5B, and FIG. 6-FIG. 9.

At block 1421, and as described above with respect to FIGS. 4, 5A, and 5B, operation 421A, the UE transmits, to a CN (e.g., CN 110 of FIGS. 1A, 5A, 5B, and 6-9), a first registration request message indicating a first security context.

At block 1423, and as described above with respect to FIGS. 4, 5A and 5B, operation 423, the UE receives, from the CN, an authentication request message indicating a second security context.

As described above with respect to FIG. 5B, block 532, the UE starts a timer.

As described above with respect to FIG. 1A and FIG. 5B, block 130B, the UE performs a temporary local release for a communication session with the CN.

As described above with respect to FIG. 5B, block 536, the UE initiates one or more maintenance operations.

At block 1438, and as described above with respect to FIG. 5B, block 538, the UE resumes a registered state when the one or more maintenance operations complete before the timer expires.

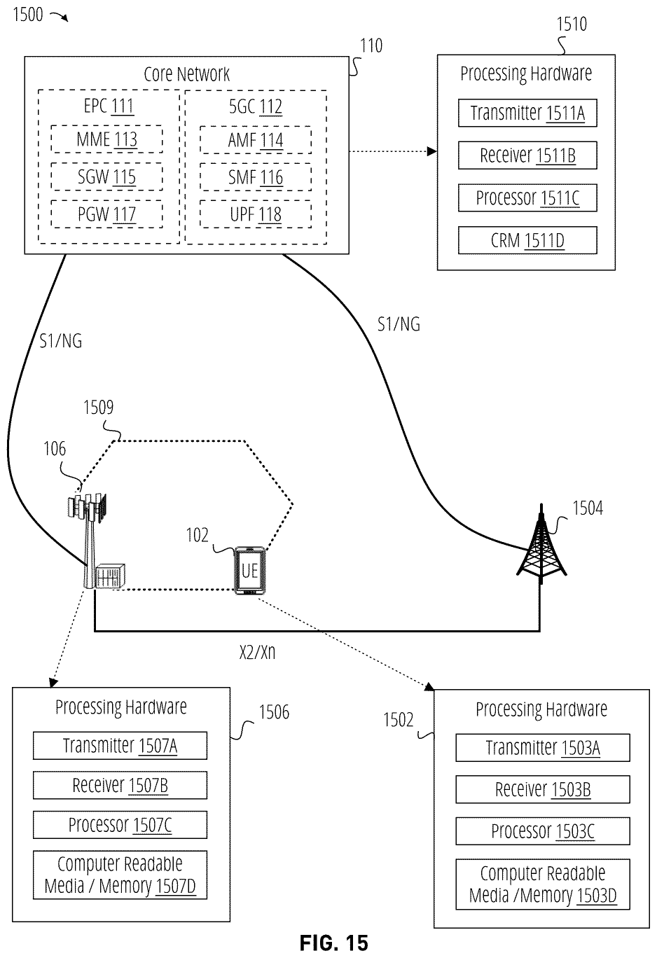

FIG. 15 is a block diagram of an example wireless communication system 1500 showing hardware features and communication interfaces. The example wireless communication system 1500 may be an implementation of the example wireless communication system 100 of FIG. 1A. The depicted hardware configurations may omit certain components well-understood to be frequently implemented in such electronic devices, such as displays, peripherals, power supplies, and the like. The wireless communication system 1500 includes the same elements as described with reference to FIG. 1A, including the UE 102, the BS 106, and the CN 110. The UE 102 can support at least a 5G NR (or simply, “NR”) or E-UTRA air interface to communicate with the BS 106. The BS 106 connects to the CN 110 via an interface (e.g., S1 or NG interface). The BS 106 manages one or more cells 1509 and can connect to other base stations (such as the BS 1504) via an interface (e.g., X2 or Xn interface) for interconnecting NG RAN nodes.

The base station 106 is equipped with processing hardware 1506 that can include a receiver 1507B configured to receive data in the uplink direction. The processing hardware 1506 can also include a transmitter 1507A configured to transmit data in the downlink direction. The processing hardware further can one or more general-purpose processor(s) 1507C (e.g., CPUs) and a non-transitory computer-readable memory 1507D storing instructions that the one or more general-purpose processors execute. Additionally, or alternatively, the processing hardware 1506 can include special-purpose processing units. The processor 1507C may include, for example, one or more central processing units, graphics processing units (GPUs), or other application-specific integrated circuits (ASIC), and the like. CRM 1507D may include any suitable memory or storage device such as random-access memory (RAM), static RAM (SRAM), dynamic RAM (DRAM), non-volatile RAM (NVRAM), read-only memory (ROM), or Flash memory usable to store device data of the BS 106.

The UE 102 is equipped with processing hardware 1502 that can include one or more general-purpose processors such as CPUs and non-transitory computer-readable memory 1503D storing machine-readable instructions executable on the one or more general-purpose processors, and/or special-purpose processing units. The processing hardware 1502 can also include a transmitter 1503A configured to transmit data in the downlink direction. The processing hardware further can include a receiver 1503B configured to receive data in the uplink direction. The transmitter 1503A and the receiver 1503B may form a communication unit. The processing hardware 1502 in an example implementation includes a processor 1503C (which may be referred to as a processing system) to process data that the UE 102 will transmit in the uplink direction, or process data received by UE 102 in the downlink direction. The processor(s) 1503C may include, for example, one or more central processing units, graphics processing units (GPUs), or other application-specific integrated circuits (ASIC), and the like. To illustrate, the processor(s) 1503C may include an application processor (AP) utilized by the UE 102 to execute an operating system and various user-level software applications, as well as one or more processors utilized by modems or a baseband processor. The computer readable media/memory (CRM) 1503D may include any suitable memory or storage device such as random-access memory (RAM), static RAM (SRAM), dynamic RAM (DRAM), non-volatile RAM (NVRAM), read-only memory (ROM), Flash memory, solid-state drive (SSD) or other mass-storage devices, and the like useable to store one or more sets of executable software instructions and associated data that manipulate the one or more processor(s) 1503C and other components of the processing hardware 1502 to perform the various functions described herein and attributed to the UE 102. The sets of executable software instructions include, for example, an operating system (OS) and various drivers (not shown), and various software applications (not shown), which are executable by processor(s) 1503C to enable user-plane communication, control-plane signaling, and user interaction with the UE 102.

The CN 110 can be an EPC 111 and/or a 5GC 112. Among other components, the EPC 111 can include an SGW 115, an MME 113, and a PGW 117. The SGW 115 in general is configured to transfer user-plane packets related to audio calls, video calls, Internet traffic, etc., and the MME 113 is configured to manage authentication, registration, paging, and other related functions. The PGW 117 provides connectivity from the UE 102 to one or more external packet data networks, e.g., an Internet network and/or an Internet Protocol (IP) Multimedia Subsystem (IMS) network.

The 5GC 112 includes a UPF 118, an AMF 114, and/or SMF 116. Generally speaking, the UPF 118 is configured to transfer user-plane packets related to audio calls, video calls, Internet traffic, etc., the AMF 114 is configured to manage authentication, registration, paging, and other related functions, and the SMF 116 is configured to manage PDU sessions.

The core network 110 can be implemented by one or more processing elements (shown as processing hardware 1510). The processing hardware 1510 can include a transmitter 1511A, a receiver 1511B, a processor 1511C, and a CRM 1511D, similar to corresponding components described with reference to processing hardware 1502 and processing hardware 1506.

FIG. 1A through FIG. 15 and the operations described herein are examples meant to aid in understanding example implementations and should not be used to limit the potential implementations or limit the scope of the claims. Some implementations may perform additional operations, fewer operations, operations in parallel or in a different order, and some operations differently.

Aspects of the subject matter described in this disclosure can be implemented as a computer-readable medium having stored therein instructions which, when executed by a processor, causes the processor to perform any one of the above-mentioned functionalities. Aspects of the subject matter described in this disclosure can be implemented as a system having means for implementing any one of the above-mentioned functionalities. Aspects of the subject matter described in this disclosure can be implemented as an apparatus having one or more processors configured to perform one or more operations from any one of the above-mentioned functionalities.

The following additional considerations may apply to the foregoing and the following discussions. Generally speaking, description for one of the above figures can apply to another of the above figures. Any event or block described above can be optional. For example, an event or block with dashed lines can be optional. In some implementations, “message” is used and can be replaced by “information element (IE),” and vice versa. In some implementations, “IE” is used and can be replaced by “field,” and vice versa. In some implementations, “configuration” can be replaced by “configurations” or “configuration parameters,” and vice versa. In some implementations, “some” means “one or more.” In some implementations, “at least one” means “one or more.” The “eNB” can be replaced by “base station,” “gNB,” “6G base station,” “evolved gNB,” or 6G gNB. “MME” can be replaced by AMF or evolved AMF or 6G AMF. “Core network (CN)” can be replaced by EPC, 5GC or 6GC.

Unless defined otherwise, technical and scientific terms used herein have the same meaning as is commonly understood by one of ordinary skill in the art to which this specification belongs. The terms “first,” “second,” and the like, as used herein do not denote any order, quantity, or importance, but rather are used to distinguish one element from another. The use of terms “including,” “comprising” or “having” and variations thereof herein are meant to encompass the items listed thereafter and equivalents thereof as well as additional items. The terms “connected” and “coupled” are not restricted to physical or mechanical connections or couplings and can include electrical connections or couplings, whether direct or indirect. Furthermore, terms “circuit” and “circuitry” and “control unit” may include either a single component or a plurality of components, which are either active and/or passive and are connected or otherwise coupled together to provide the described function. In addition, the term operationally coupled as used herein includes wired coupling, wireless coupling, electrical coupling, magnetic coupling, radio communication, software based communication, or combinations thereof.

Some or all of the foregoing or the following implementations can be jointly combined or formed to be a new or another one implementation. The foregoing or the following techniques can be used to solve at least (but not limited to) the issue(s) or scenario(s) mentioned in this disclosure. Any two or more than two of the foregoing or the following paragraphs, (sub)-bullets, points, actions, or claims described in each method/technique/implementation may be combined logically, reasonably, and properly to form a specific method. Any sentence, paragraph, (sub)-bullet, point, action, or claim described in each of the foregoing or the following technique(s)/implementation(s)/concept(s) may be implemented independently and separately to form a specific method. Dependency, such as “based on,” “more specifically,” “where” or etc., in technique(s)/implementation(s)/concept(s) mentioned in this disclosure is just one possible implementation which would not restrict the specific method.

As used herein, the terms “user device”, “user equipment” (for example, UE 102), “wireless communication device”, “mobile communication device”, “communication device”, or “mobile device” refer to any one or all of cellular telephones, smartphones, portable computing devices, personal or mobile multi-media players, laptop computers, tablet computers, smartbooks, Internet-of-Things (IoT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers, point-of-sale (POS) terminals, health monitoring devices, drones, cameras, media-streaming dongles or another personal media devices, wearable devices such as smartwatches, wireless hotspots, femtocells, broadband routers or other types of routers, and similar electronic devices which include a programmable processor and memory and circuitry configured to perform operations as described herein. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain techniques are described in this disclosure as including logic or a number of components or modules. Modules can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

As used herein, the terms “component” and “module” are intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

As used herein, a phrase referring to a list of items separated by “or” refers to any combination of those items, including single members. For example, “a, b, or c” is intended to cover the possibilities of: a only, b only, c only, a combination of a and b, a combination of a and c, a combination of b and c, and a combination of a and b and c.

In this disclosure, an expression of “X/Y” may include meaning of any of the following: “X or Y” or “X and Y” or “X and/or Y.” An expression of “(A) B” or “B (A)” may include concept of “only B.” An expression of “(A) B” or “B (A)” may include the concept of “A+B” or “B+A.”

In this disclosure, the term “can” indicates a capability, or alternatively indicates a possible implementation option. The term “may” indicates a permission or a possible implementation option.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

As described above, some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes.

What is claimed is:

1. A method for wireless communication by a user equipment (UE) (102), comprising:
transmitting, to a core network (CN), a first registration request message indicating a first security context;
receiving, from the CN, an authentication request message indicating a second security context (188);
starting a maintenance operations timer indicating an allowable time for maintenance operations;
performing a temporary local release for a communication session;
initiating one or more of the maintenance operations; and
resuming at least one of a registered state or one or more registration operations when the one or more maintenance operations complete before the maintenance operations timer expires.

2. The method of claim 1, wherein the first security context comprises a mapped security context.

3. The method of claim 1, wherein the second security context comprises a partial-native security context.

4. The method of claim 1, wherein the first security context includes a first next-generation key set identifier (ngKSI).

5. The method of claim 4, wherein the second security context includes a second ngKSI different from the first ngKSI.

6. The method of claim 1, further comprising:
receiving, from the CN, a security mode command indicating a third security context;
comparing the second security context with the third security context; and
when the second security context matches the third security context, transmitting, to the CN, a security mode accept message indicating the second security context.

7. The method of claim 6, wherein the comparing the second security context with the third security context includes comparing a first key in the third security context with a second key in the second security context.

8. The method of claim 1, wherein the maintenance operations include one or more of:
updating software on the UE;
performing a frequency shift for a DSDM SIM; or
performing radio link failure recovery operations.

9. The method of claim 1, further comprising setting the maintenance operations timer based on at least one of:
a minimum timer value;
a maximum timer value based on a predetermined or configurable number of retry times;
a residual re-TX timer value;
an expected or on-going network re-TX timer value;
an expected time for the CN to initiate a security mode control (SMC) procedure;
a minimum timer as a network residual re-TX timer;
a residual network re-TX timer;
an re-TX timer value; or
a network re-TX timer value.

10. The method of claim 1, further comprising synchronizing a fourth security context with the CN when the maintenance operations timer expires before the one or more maintenance operations are completed.

11. The method of claim 10, wherein the synchronizing the fourth security context with the CN includes one or more of:
transmitting one or more second registration requests indicating no key is available,
switching from operating using a first radio access technology (RAT) to operating using a second RAT, or
transmitting a deregistration request to the CN.

12. The method of claim 11, wherein:
the first RAT comprises a 5G technology and the second RAT comprises a long term evolution (LTE) technology; or
the first RAT comprises a 6th generation (6G) technology and the second RAT comprises the 5G technology.

13. The method of claim 11, wherein the synchronizing further includes the transmitting of the one or more second registration requests, and the one or more second registration requests include an international mobile subscriber identity (IMSI).

14. The method of claim 11, wherein the synchronizing further includes transmitting, to the CN, at least one attach request.

15. The method of claim 14, wherein the at least one attach request includes an indication of at least one of a globally unique temporary identifier (GUTI) or an IMSI.

16. An apparatus, comprising:
a communication unit; and
a processing system configured to control the communication unit to: transmit, to a core network (CN), a first registration request message indicating a first security context;
receive, from the CN, an authentication request message indicating a second security context;
start a maintenance operations timer indicating an allowable time for maintenance operations;
perform a temporary local release for a communication session;
initiate one or more of the maintenance operations; and
resume at least one of a registered state or one or more registration operations when the one or more maintenance operations complete before the maintenance operations timer expires.

17. The apparatus of claim 16, wherein the processing system is further configured to control the communication unit to:
receive, from the CN, a security mode command indicating a third security context;
compare the second security context with the third security context; and
when the second security context matches the third security context, transmit, to the CN, a security mode accept message indicating the second security context.

18. The apparatus of claim 16, wherein the first security context includes at least one of a mapped security context or a first next-generation key set identifier (ngKSI).

19. The apparatus of claim 18, wherein the second security context includes at least one of a partial-native security context or a second ngKSI different from the first ngKSI.
